(19) United States
(12) Patent Application Publication
(10) Pub. No.: US 2022/0137835 A1
(43) Pub. Date: May 5, 2022

(54) SYSTEMS AND METHODS FOR PARITY-BASED FAILURE PROTECTION FOR STORAGE DEVICES

(71) Applicant: Kioxia Corporation, Tokyo (JP)

(72) Inventors: Krishna MALAKAPALLI, San Jose, CA (US); Jeremy WERNER, San Jose, CA (US); Kenichi IWAI, Tokyo (JP)

(73) Assignee: Kioxia Corporation, Tokyo (JP)

(21) Appl. No.: 17/133,373

(22) Filed: Dec. 23, 2020

Related U.S. Application Data
(60) Provisional application No. 63/108,196, filed on Oct. 30, 2020.

(51) Int. Cl. G06F 3/06; G06F 9/30

(52) U.S. Cl. CPC G06F 3/0619; G06F 9/30029; G06F 3/0659; G06F 3/0689; G06F 3/0656

(57) ABSTRACT

Various implementations described herein relate to systems and methods for providing data protection and recovery for drive failures, including receiving, by a controller of a first storage device, a request from the host. In response to receiving the request, the controller transfers new data from a second storage device. The controller determines an XOR result by performing an XOR operation of the new data and existing data, the existing data is stored in a non-volatile storage.

### CROSS-REFERENCE TO RELATED PATENT APPLICATIONS

This application claims priority to U.S. Provisional Patent Application Ser. No. 63/108,196, entitled “System and Methods for Parity-Based Failure Protection for Storage Devices” filed Oct. 30, 2020, the contents of which being hereby incorporated by reference in its entirety and for all purposes as if completely and fully set forth herein.

### TECHNICAL FIELD

The present disclosure generally relates to systems, methods, and non-transitory processor-readable media for data protection and recovery for drive failures in data storage devices.

### BACKGROUND

Redundant Array of Inexpensive Drives (RAID) can be implemented on non-volatile memory device based drives to achieve protection from drive failures. Various forms of RAID can be broadly categorized based on whether data is being replicated or parity protected. Replication is more expensive in terms of storage cost because replication doubles the number of devices needed.

On the other hand, parity protection typically require storage cost lower than that of replication. In the example of RAID 5, one additional device is needed to provide protection for a single device failure at a given time by holding parity data for a minimum of two data devices. When RAID 5 parity protection is employed, the additional storage cost as a percentage of the total cost is typically reduced as the number of devices being protected in a RAID group increases.

In the case of RAID 6, which offers protection for up to two devices failing at the same time, two additional devices are needed to hold parity data for a minimum of two data devices. Similarly, when RAID 6 parity protection is employed, the additional storage cost as a percentage of the total cost is reduced as the number of devices being protected in a RAID group increases. To alleviate the risk of failure of the drives holding the parity data, the drives on which the parity data is stored are rotated.

Other variations of parity protection include combining replication with parity protection (e.g., as in RAID 51 and RAID 61), to vary the stripe sizes used between devices to match a given application, and so on.

### SUMMARY

In some arrangements, a first storage device includes a non-volatile storage and a controller. The controller is configured to receive a request from a host operatively coupled to the first storage device, in response to receiving the request, transfer new data from a second storage device, and determine an XOR result by performing an XOR operation of the new data and existing data, the existing data is stored in the non-volatile storage.

In some arrangements, a first storage device includes a non-volatile storage and a controller. The controller is configured to receive a request from a second storage device, in response to receiving the request, transfer new data from the second storage device, and determine an XOR result by performing an XOR operation of the new data and existing data, the existing data is stored in the non-volatile storage.

### BRIEF DESCRIPTION OF THE FIGURES

FIG. 1 shows a block diagram of examples of a system including storage devices and a host, according to some implementations.

FIG. 2A is a block diagram illustrating an example method for performing data update, according to some implementations.

FIG. 2B is a flowchart diagram illustrating an example method for performing data update, according to some implementations.

FIG. 3A is a block diagram illustrating an example method for performing parity update, according to some implementations.

FIG. 3B is a flowchart diagram illustrating an example method for performing parity update, according to some implementations.

FIG. 4A is a block diagram illustrating an example method for performing data recovery, according to some implementations.

FIG. 4B is a flowchart diagram illustrating an example method for performing data recovery, according to some implementations.

FIG. 5A is a block diagram illustrating an example method for bringing a spare storage device into service, according to some implementations.

FIG. 5B is a flowchart diagram illustrating an example method for bringing a spare storage device into service, according to some implementations.

FIG. 6 is a process flow diagram illustrating an example method for providing data protection and recovery for drive failures, according to some implementations.

FIG. 7A is a block diagram illustrating an example method for performing parity update, according to some implementations.

FIG. 7B is a flowchart diagram illustrating an example method for performing parity update, according to some implementations.

FIG. 8A is a block diagram illustrating an example method for performing data recovery, according to some implementations.

FIG. 8B is a flowchart diagram illustrating an example method for performing data recovery, according to some implementations.

FIG. 9A is a block diagram illustrating an example method for bringing a spare storage device into service, according to some implementations.

FIG. 9B is a flowchart diagram illustrating an example method for bringing a spare storage device into service, according to some implementations.

FIG. 10 is a process flow diagram illustrating an example method for providing data protection and recovery for drive failures, according to some implementations.

FIG. 11 is a process flow diagram illustrating an example method for providing data protection and recovery for drive failures, according to some implementations.

FIG. 12 is a schematic diagram illustrating a host-side view for updating data, according to some implementations.

FIG. 13 is a schematic diagram illustrating a placement of parity data, according to some implementations.

### DETAILED DESCRIPTION

Various challenges face parity-based protection. Presently, a vast majority of implementations is achieved through a dedicated Disk Array Controller (DAC). The DAC computes the parity data by performing an exclusive-or (XOR) of each stripe of data per data disk in a given RAID group and stores the resulting parity data on one or more parity disks. The DAC is typically attached to a main Central Processing Unit (CPU) over a Peripheral Component Interconnect Express (PCIe) bus or network, while the DAC uses storage-specialized interconnects and protocols (interfaces) such as but not limited to, AT Attachment (ATA), Small Computer System Interface (SCSI), Fibre Channel, and Serial Attached SCSI (SAS) to connect and communicate with the disks. With the storage-specialized interconnects, the dedicated hardware controller had been needed to translate between a PCIe bus and the storage interfaces like SCSI or Fibre Channel.

Applicant has recognized that the evolution of non-volatile memory based storage devices such as Solid State Drives (SSDs) has fundamentally changed the system architecture in that storage devices are attached directly onto the PCIe bus over a Non-Volatile Memory Express (NVMe) interface, thus eliminating inefficiencies in the path and optimizing cost, power, and performance. Although the functionalities of the DAC is still needed for SSD failure protection, the DAC functionality is migrating from being a dedicated hardware controller to software running on a general purpose CPU.

With access times in Hard Disk Drives (HDDs) being in the order of milliseconds, DAC inefficiencies were not exposed. Emergence of SSDs has reduced data access times, thus placing much stringent requirements onto the DAC to export and aggregate performance of a multitude of SSDs. Applicant recognizes that as access times with SSDs decreased by orders of magnitude into 10 s of microseconds, the conventional implementations of the DAC become inefficient as performance of the DAC translates to the performance of SSDs.

Due to the rise of NVMe, the interfaces used for HDDs need to be upgraded to be compatible with SSDs. Such interfaces define the manner in which commands are delivered, status is returned, and data exchanged between a host and the storage device. The interfaces can optimize and streamline connection directly to the CPU without being bogged down by an intermediary interface translator.

Furthermore, the cost of HDDs (per GB) have been reduced significantly as SSD adoption began to increase, partly due to improved capacity which has been provided in HDDs to differentiate over SSDs in the marketplace. However, improved capacity came at the cost of performance, particularly with the reconstruction of data when drives in a RAID group fail. Consequently, DAC vendors moved from using parity-based protection to replication-based protection for HDDs. The data storage and access times of the HDDs had been slower than those of the SSDs, thus packing more capacity made average performance of HDDs worse. In that regard, DAC vendors did not want to slow down the HDD any further by using parity-based protection. Thus, replication-based protection has become pervasively used almost de facto in standard DACs for HDDs. When SSDs came along with requirements in the orders of magnitude improvement greater for the DAC to address, it was opportunistic and timely for DAC to simply reuse replication-based protection for SSDs, as well.

Accordingly, parity-based protection for SSDs has not kept up with architectural changes that were taking place system-wide. In addition, a cost barrier and access barrier were also erected on main CPUs in the form of special Stock Keeping Units (SKUs) with limited availability to select customers. DAC vendors lost the same freedom to offer parity-based protection for SSDs as the DAC vendors have for replication-based SSDs.

As a result, implementing RAID 5 and RAID 6 parity-based protection for SSDs has become even more difficult to implement.

Conventionally, RAID (e.g., RAID 5 and RAID 6) redundancy is created for storage devices (e.g., SSDs) by relying upon the host to perform the XOR computations and updating the parity data on SSDs. The SSDs perform their usual function of reading or writing data to and from the storage media (e.g., the memory array) unaware of whether data is parity data or not. Thus, in RAID 5 and RAID 6, the computational overhead and the extra data generation and movement often become the performance bottleneck over the storage media.

The arrangements disclosed herein relate to parity-based protection schemes that are cost-effective solutions for SSD failure protection without compromising the need to deliver to business needs faster. The present disclosure improves parity-based protection while creating solutions that are in tune with the current system architecture and evolving changes. In some arrangements, the present disclosure relates to cooperatively performing data protection and recovery operations between two or more elements of a storage system. While non-volatile memory devices are presented as examples herein, the disclosed schemes can be implemented on any storage system or device that is connected over an interface to a host and temporarily or permanently stores data for the host for later retrieval.

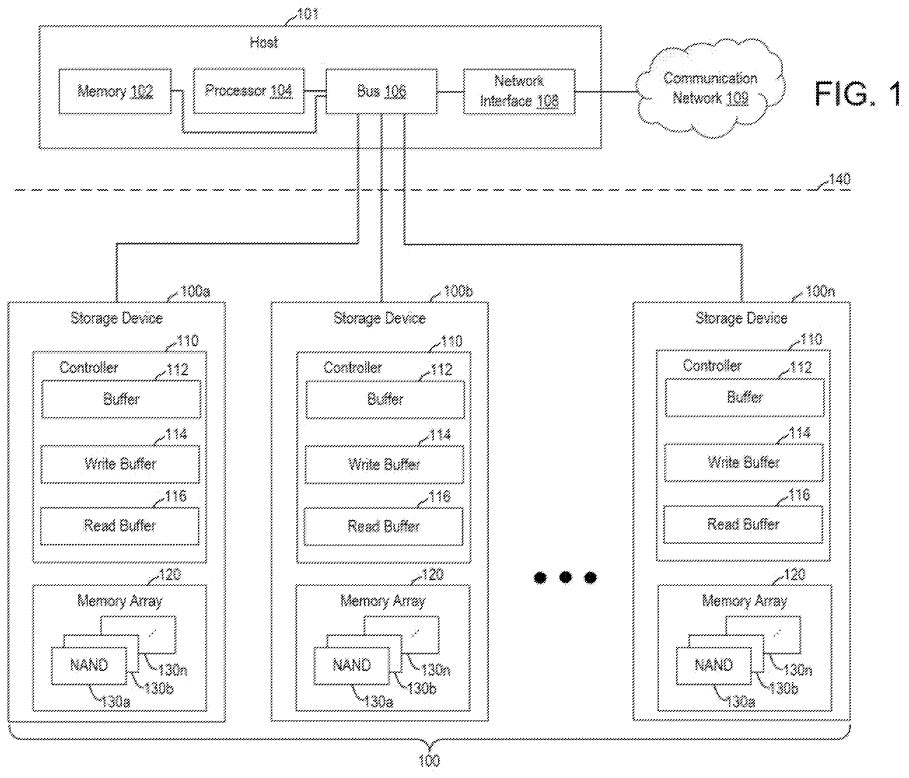

To assist in illustrating the present implementations, FIG. 1 shows a block diagram of a system including storage devices 100a, 100b, 100n (collectively, storage devices 100) coupled to a host 101 according to some examples. The host 101 can be a user device operated by a user or an autonomous central controller of the storage devices 100, where the host 101 and storage devices 100 correspond to a storage subsystem or storage appliance. The host 101 can be connected to a communication network 109 (via the network interface 108) such that other host computers (not shown) may access the storage subsystem or storage appliance via the communication network 109. Examples of such a storage subsystem or appliance include an All Flash Array (AFA) or a Network Attached Storage (NAS) device. As shown, the host 101 includes a memory 102, a processor 104, and an bus 106. The processor 104 is operatively coupled to the memory 102 and the bus 106. The processor 104 is sometimes referred to as a Central Processing Unit (CPU) of the host 101, and configured to perform processes of the host 101.

The memory 102 is a local memory of the host 101. In some examples, the memory 102 is or a buffer, sometimes referred to as a host buffer. In some examples, the memory 102 is a volatile storage. In other examples, the memory 102 is a non-volatile persistent storage. Examples of the memory 102 include but are not limited to, Random Access Memory (RAM), Dynamic Random Access Memory (DRAM), Static RAM (SRAM), Magnetic RAM (MRAM), Phase Change Memory (PCM), and so on.

The bus 106 includes one or more of software, firmware, and hardware that provide an interface through components of the host 101 can communicate. Examples of components include but are not limited to, the processor 104, network cards, storage devices, the memory 102, graphic cards, and so on. In addition, the host 101 (e.g., the processor 104) can communicate with the storage devices 100 using the bus 106. In some examples, the storage devices 100 are directly attached or communicably coupled to the bus 106 over a suitable interface 140. The bus 106 is one or more of a serial, a PCIe bus or network, a PCIe root complex, an internal PCIe switch, and so on.

The processor 104 can execute an Operating System (OS), which provides a filesystem and applications which use the filesystem. The processor 104 can communicate with the storage devices 100 (e.g., a controller 110 of each of the storage devices 100) via a communication link or network. In that regard, the processor 104 can send data to and receive data from one or more of the storage devices 100 using the interface 140 to the communication link or network. The interface 140 allows the software (e.g., the filesystem) running on the processor 104 to communicate with the storage devices 100 (e.g., the controllers 110 thereof) via the bus 106. The storage devices 100 (e.g., the controllers 110 thereof) are operatively coupled to the bus 106 directly via the interface 140. While the interface 140 is conceptually shown as a dashed line between the host 101 and the storage devices 100, the interface 140 can include one or more controllers, one or more physical connectors, one or more data transfer protocols including namespaces, ports, transport mechanism, and connectivity thereof. While the connection between the host 101 and the storage devices 100a,b . . . n, is shown as a direct link, in some implementations the link may comprise a network fabric which may include networking components such as bridges and switches.

To send and receive data, the processor 104 (the software or filesystem run thereon) communicates with the storage devices 100 using a storage data transfer protocol running on the interface 140. Examples of the protocol include but is not limited to, the SAS, Serial ATA (SATA), and NVMe protocols. In some examples, the interface 140 includes hardware (e.g., controllers) implemented on or operatively coupled to the bus 106, the storage devices 100 (e.g., the controllers 110), or another device operatively coupled to the bus 106 and/or the storage device 100 via one or more suitable networks. The interface 140 and the storage protocol running thereon also includes software and/or firmware executed on such hardware.

In some examples the processor 104 can communicate, via the bus 106 and the network interface 108, with the communication network 109. Other host systems (not shown) attached or communicably coupled to the communication network 109 can communicate with the host 101 using a suitable network storage protocol, examples of which include, but are not limited to, NVMe over Fabrics (NVMeoF), iSCSI, Fibre Channel (FC), Network File System (NFS), Server Message Block (SMB), and so on. The network interface 108 allows the software (e.g., the storage protocol or filesystem) running on the processor 104 to communicate with the external hosts attached to the communication network 109 via the bus 106. In this manner, network storage commands may be issued by the external hosts and processed by the processor 104, which can issue storage commands to the storage devices 100 as needed. Data can thus be exchanged between the external hosts and the storage devices 100 via the communication network 109. In this example, any data exchanged is buffered in the memory 102 of the host 101.

In some examples, the storage devices 100 are located in a datacenter (not shown for brevity). The datacenter may include one or more platforms or rack units, each of which supports one or more storage devices (such as but not limited to, the storage devices 100). In some implementations, the host 101 and storage devices 100 together form a storage node, with the host 101 acting as a node controller. An example of a storage node is a Kioxia Kumoscale storage node. One or more storage nodes within a platform are connected to a Top of Rack (TOR) switch, each storage node connected to the TOR via one or more network connections, such as Ethernet, Fiber Channel or InfiniBand, and can communicate with each other via the TOR switch or another suitable intra-platform communication mechanism. In some implementations, storage devices 100 may be network attached storage devices (e.g. Ethernet SSDs) connected to the TOR switch, with host 101 also connected to the TOR switch and able to communicate with the storage devices 100 via the TOR switch. In some implementations, at least one router may facilitate communications among the storage devices 100 in storage nodes in different platforms, racks, or cabinets via a suitable networking fabric. Examples of the storage devices 100 include non-volatile devices such as but are not limited to, Solid State Drive (SSDs), Ethernet attached SSDs, a Non-Volatile Dual In-line Memory Modules (NVDIMMs), a Universal Flash Storage (UFS), a Secure Digital (SD) devices, and so on.

Each of the storage devices 100 includes at least a controller 110 and a memory array 120. Other components of the storage devices 100 are not shown for brevity. The memory array 120 includes NAND flash memory devices 130a-130n. Each of the NAND flash memory devices 130a-130n includes one or more individual NAND flash dies, which are NVM capable of retaining data without power. Thus, the NAND flash memory devices 130a-130n refer to multiple NAND flash memory devices or dies within the flash memory device 100. Each of the NAND flash memory devices 130a-130n includes one or more dies, each of which has one or more planes. Each plane has multiple blocks, and each block has multiple pages.

While the NAND flash memory devices 130a-130n are shown to be examples of the memory array 120, other examples of non-volatile memory technologies for implementing the memory array 120 include but are not limited to, non-volatile (battery-backed) DRAM, Magnetic Random Access Memory (MRAM), Phase Change Memory (PCM), Ferro-Electric RAM (FeRAM), and so on. The arrangements described herein can be likewise implemented on memory systems using such memory technologies and other suitable memory technologies.

Examples of the controller 110 include but are not limited to, an SSD controller (e.g., a client SSD controller, a datacenter SSD controller, an enterprise SSD controller, and so on), a UFS controller, or an SD controller, and so on.

The controller 110 can combine raw data storage in the plurality of NAND flash memory devices 130a-130n such that those NAND flash memory devices 130a-130n function logically as a single unit of storage. The controller 110 can include processors, microcontrollers, a buffer memory 111 (e.g., buffer 112, 114, 116), error correction systems, data encryption systems, Flash Translation Layer (FTL) and flash interface modules. Such functions can be implemented in hardware, software, and firmware or any combination thereof. In some arrangements, the software/firmware of the controller 110 can be stored in the memory array 120 or in any other suitable computer readable storage medium.

The controller 110 includes suitable processing and memory capabilities for executing functions described herein, among other functions. As described, the controller 110 manages various features for the NAND flash memory devices 130a-130n including but not limited to, I/O handling, reading, writing/programming, erasing, monitoring, logging, error handling, garbage collection, wear leveling, logical to physical address mapping, data protection (encryption/decryption, Cyclic Redundancy Check (CRC)), Error Correction Coding (ECC), data scrambling, and the like. Thus, the controller 110 provides visibility to the NAND flash memory devices 130a-130n.

The buffer memory 111 is a memory device local to, and operatively coupled to, the controller 110. For instance, the buffer memory 111 can be an on-chip SRAM memory located on the chip of the controller 110. In some implementations, the buffer memory 111 can be implemented using a memory device of the storage device 110 external to the controller 110. For instance, the buffer memory 111 can be DRAM located on a chip other than the chip of the controller 110. In some implementations, the buffer memory 111 can be implemented using memory devices both internal and external to the controller 110 (e.g., both on and off the chip of the controller 110). For example, the buffer memory 111 can be implemented using both an internal SRAM and an external DRAM, which are transparent/exposed and accessible by other devices via the interface 140, such as the host 101 and other storage devices 100. In this example, the controller 110 includes an internal processor that uses memory addresses within a single address space and the memory controller, which controls both the internal SRAM and external DRAM, selects whether to place the data on the internal SRAM and an external DRAM based on efficiency. In other words, the internal SRAM and external DRAM are addressed like a single memory. As shown, the buffer memory 111 includes the buffer 112, the write buffer 114, and the read buffer 116. In other words, the buffer 112, the write buffer 114, and the read buffer 116 can be implemented using the buffer memory 111.

The controller 110 includes a buffer 112, which is sometimes referred to as a drive buffer or a Controller Memory Buffer (CMB). Besides being accessible by the controller 110, the buffer 112 is accessible by other devices via the interface 140, such as the host 101 and other storage devices 100a, 100b, 100n. In that manner, the buffer 112 (e.g., addresses of memory locations within the buffer 112) is exposed across the bus 106, and any device operatively coupled to the bus 106 can issue commands (e.g., read commands, write commands, and so on) using addresses that correspond to memory locations within the buffer 112 in order to read data from those memory locations within the buffer and write data to those memory locations within the buffer 112. In some examples, the buffer 112 is a volatile storage. In some examples, the buffer 112 is a non-volatile persistent storage, which may offer improvements in protection against unexpected power loss of one or more of the storage devices 100. Examples of the buffer 112 include but are not limited to, RAM, DRAM, SRAM, MRAM, PCM, and so on. The buffer 112 may refer to multiple buffers each configured to store data of a different type, as described herein.

In some implementations, as shown in FIG. 1, the buffer 112 is a local memory of the controller 110. For instance, the buffer 112 can be an on-chip SRAM memory located on the chip of the controller 110. In some implementations, the buffer 112 can be implemented using a memory device of the storage device 110 external to the controller 110. For instance, the buffer 112 can be DRAM located on a chip other than the chip of the controller 110. In some implementations, the buffer 112 can be implemented using memory devices both internal and external to the controller 110 (e.g., both on and off the chip of the controller 110). For example, the buffer 112 can be implemented using both an internal SRAM and an external DRAM, which are transparent/exposed and accessible by other devices via the interface 140, such as the host 101 and other storage devices 100. In this example, the controller 110 includes an internal processor uses memory addresses within a single address space and the memory controller, which controls both the internal SRAM and external DRAM, selects whether to place the data on the internal SRAM and an external DRAM based on efficiency. In other words, the internal SRAM and external DRAM are addressed like a single memory.

In one example concerning a write operation, in response to receiving data from the host 101 (via the host interface 140), the controller 110 acknowledges the write commands to the host 101 after writing the data to a write buffer 114. In some implementations the write buffer 114 may be implemented in a separate, different memory than the buffer 112, or the write buffer 114 may be a defined area or part of the memory comprising buffer 112, where only the CMB part of the memory is accessible by other devices, but not the write buffer 114. The controller 110 can write the data stored in the write buffer 114 to the memory array 120 (e.g., the NAND flash memory devices 130a-130n). Once writing the data to physical addresses of the memory array 120 is complete, the FTL updates mapping between logical addresses (e.g., Logical Block Address (LBAs)) used by the host 101 to associate with the data and the physical addresses used by the controller 110 to identify the physical locations of the data. In another example concerning a read operation, the controller 110 includes another buffer 116 (e.g., a read buffer) different from the buffer 112 and the buffer 114 to store data read from the memory array 120. In some implementations the read buffer 116 may be implemented in a separate, different memory than the buffer 112, or the read buffer 116 may be a defined area or part of the memory comprising buffer 112, where only the CMB part of the memory is accessible by other devices, but not the read buffer 116.

While non-volatile memory devices (e.g., the NAND flash memory devices 130a-130n) are presented as examples herein, the disclosed schemes can be implemented on any storage system or device that is connected to the host 101 over an interface, where such system temporarily or permanently stores data for the host 101 for later retrieval.

In some examples, the storage devices 100 form a RAID group for parity protection. That is, one or more of the storage devices 100 stores parity data (e.g., parity bits) for data stored on those devices and/or data stored on other ones of the storage devices 100.

Traditionally, to update parity data (or parity) on a parity drive in a RAID 5 group, 2 read I/O operations, 2 write I/O operations, 4 transfers over the bus 106, and 4 memory buffer transfers are needed. All such operations require CPU cycles, Submission Queue (SQ)/Completion Queue (CQ) entries, Context Switches, and so on, on the processor 104. In addition, the transfer performed between the processor 104 and the memory 102 consume buffer space and bandwidth between the processor 104 and the memory 102. Still further, the communication of data between the processor 104 and the bus 106 consume bandwidth of the bus 106, where the bandwidth of the bus 106 is considered a precious resource because the bus 106 serves as an interface among the different components of the host 101. Accordingly, traditional parity update schemes consume considerable resources (e.g., bandwidth, CPU cycles, and buffer space) on the host 101.

Some arrangements disclosed herein relate to achieving parity-based drive failure protection (e.g., RAID) based on Peer-to-Peer (P2P) transfers among the storage devices 100. In a drive failure protection scheme using P2P transfers, the local memory buffers (e.g., the buffers 112) of the storage devices 100 are used to perform data transfers from one storage device (e.g., the storage device 100a) to another (e.g., the storage device 100b). Accordingly, the data no longer needs to be copied into the memory 102 of the host 101, thus reducing latency and bandwidth needed to transfer data into and out of the memory 102. Using the drive failure protection scheme described herein, the number of I/O operations can be reduced from either 4 to 2 using host-directed P2P transfer or from 4 to 1 using Device directed P2P transfer whenever data is updated on a RAIDS device. The efficiency gain not only improves performance but also reduces cost, power consumption, and network utilization.

To achieve such improved efficiencies and in some examples, the buffers 112, which are existing capability within the storage devices 100, are exposed across the bus 106 (e.g., through a Base Address Register) to the host 101 for use.

In some arrangements, the host 101 coordinates with the storage devices 100 in performing the XOR computations not only for the parity data reads and writes, but also for non-parity data reads and writes. In particular, the controller 110 can be configured to perform the XOR computations instead of receiving the XOR results from the host 101. Thus, the host 101 does not need to consume additional computational or memory resources for such operations, does not need to consume CPU cycles to send additional commands for performing the XOR computations, does not need to allocate hardware resources for related Direct Memory Access (DMA) transfers, does not need to consume submission and completion queues for additional commands, and does not need to consume additional bus/network bandwidth.

Given that the improvements gained in having the storage device 100 perform the XOR computation internally within the storage device 100, not only does the overall system cost (for the system include the host 101 and the storage device 100) become lower but also the system performance is improved. Thus, as compared to conventional RAID redundancy mechanisms, the present disclosure relates to allowing the storage devices 100 to offload functionality and repartition of functionality, resulting in fewer operations and less data movement.

In addition to offloading the XOR operations away from the host 101, the arrangements disclosed herein also leverages P2P communications between the storage devices 100 perform computational transfer of data to further improve performance, cost, power consumption, and network utilization. Specifically, the host 101 no longer need to send transient data (e.g., transient XOR data result) determined from data stored on a data device to a parity device. That is, the host 101 no longer need to transfer transient XOR result into the memory 102 from the data device and then transfer the transient XOR result out of the memory 102 into the parity device.

Instead, the memory 102 is bypassed, and the transient XOR data result is transferred from the data device to the parity device. For example, the buffer 112 (e.g., a CMB) of each of the storage devices 100 is identified by a reference. Examples of the reference include but are not limited to, an address, a CMB address, an address descriptor, an identifier, a pointer, or another suitable indicator that identifies the buffer 112 of a storage device. According to the address of a storage device, data can be transferred to that storage device from the host 101 or another storage device. The addresses of the buffers 112 of the storage devices 100 are stored within a shared address register (e.g., a shared PCIe Base Address Register) known to the host 101. For example, in NVMe, the CMB is defined by a NVMe controller register CMBLOC which defines the PCI address location of the start of the CMB and a controller register CMB SZ which is the size of the CMB. In some examples, the data device stores the XOR transient result in the buffer 112 (e.g., in a CMB). Given that the address of the data device is in a shared PCIe Base Address Register of the host 101, the host 101 sends to the parity device a write command that includes the address of the buffer 112 of the data device. The parity device can directly fetch the content (e.g., the XOR transient result) of the buffer 112 of the data device using a transfer mechanism (e.g., a DMA transfer mechanism), thus bypassing the memory 102.

Traditionally, to update data (regular, non-parity data) on a data drive in a RAID 5 group, the following steps are performed. The host 101 submits a NVMe read request over the interface 140 to the controller 110 of a data drive. In response, the controller 110 performs a NAND read into a read buffer. In other words, the controller 110 reads the data requested in the read request from the memory array 120 (one or more of the NAND flash memory devices 130a-130n) and stores it in the read buffer 116. The controller 110 transfers the data from the buffer 116 across the interface 140 into the memory 102 (e.g., an old data buffer). The old data buffer of the host 101 therefore stores the old data read from the memory array 120. The host 101 then submits a NVMe write request to the controller 110 and presents new data in a new data buffer of the host 101 to be written by the controller 110. In response, the controller 110 performs a data transfer to transfer the new data from the new data buffer of the host 101 across the NVMe interface into the write buffer 114). The controller 110 then updates the old, existing data by writing the new data into the memory array 120 (e.g., one or more of the NAND flash memory devices 130a-130n). The new data and the old data share the same logical address (e.g., LBA) and have different physical addresses (e.g., stored in different NAND pages of the NAND flash memory devices 130a-130n). The host 101 then performs an XOR operation between (i) the new data that is already residing in the new data buffer of the host 101 and (ii) existing data read from the storage device 100 and residing in the old data buffer of the host 101. The host 101 stores the result of the XOR operation (referred to as transient XOR data) in a trans-XOR host buffer of the host 101. In some cases, the trans-XOR buffer can potentially be the same as either the old data buffer or the new data buffer, as the transient XOR data can replace existing contents in those buffers, to conserve memory resources.

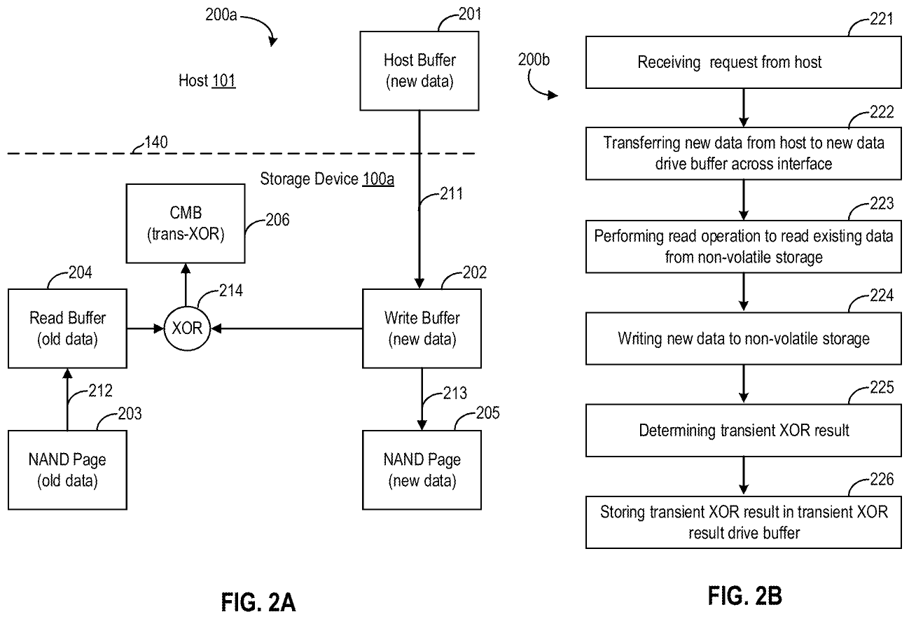

On the other hand, some arrangements for updating data stored in a data drive (e.g., the storage device 100a as an example) include performing the XOR computation within the controller 110 and over the interface 140 (e.g., the NVMe interface) to update data stored in the memory array 120 of the data drive. In that regard, FIG. 2A is a block diagram illustrating an example method 200a for performing data update, according to some implementations. Referring to FIGS. 1-2A, the method 200a provides improved I/O efficiency, host CPU efficiency, and memory resource efficiency as compared to the conventional data update method noted above. The method 200a can be performed by the host 101 and the storage device 100a. The memory 102 include a host buffer (new data) 201. The NAND page (old data) 203 and the NAND page (new data) 205 are different pages in the NAND flash memory devices 130a-130n.

In the method 200a, the host 101 submits a new type of NVMe write command or request through the bus 106 and over the interface 140 to the controller 110 of the storage device 100a. In some implementations, the new type of NVMe write command or request may resemble a traditional NVMe write command or request, but with a different command opcode or a flag to indicate that the command is not a normal NVMe write command and that the command should be processed according to the method described herein. The host 101 presents the host buffer (new data) 201 to the controller 110 to be written. In response, at 211, the controller 110 performs a data transfer to obtain the new data (regular, non-parity data) from the host buffer (new data) 201 through the bus 106 across the interface 140, and stores the new data into the write buffer (new data) 202. The write request includes a logical address (e.g., LBA) of the new data.

The controller 110 of the storage device 100a performs a NAND read into a read buffer (old data) 204, at 212. In other words, the controller 110 reads the old and existing data, corresponding to the logical address in the host's write request received at 211, from the memory array 120 (e.g., one or more NAND pages (old data) 203) and stores the old data in the read buffer (old data) 204. The one or more NAND pages (old data) 203 are pages in one or more of the NAND flash memory devices 130a-130n of the storage device 100a. The new data and the old data are data (e.g., regular, non-parity data). In other words, the old data is updated to the new data.

At 213, the controller 110 then updates the old data with the new data by writing the new data from the write buffer (new data) 202 into a NAND page (new data) 205. NAND page (new data) 205 is a different physical NAND page location than NAND Page (old data) 203 given that it is a physical property of NAND memory, and that it is not physically possible to overwrite existing data in a NAND page. Instead, a new NAND physical page is written and a Logical-to-Physical (L2P) address mapping table updated to indicate the new NAND page corresponding to the logical address used by the host 101. The controller 110 (e.g., the FTL) updates the L2P addressing mapping table to correspond the physical address of the NAND page (new data) 205 with the logical address. The controller 110 marks the physical address of the NAND page (old data) 203 for garbage collection.

At 214, the controller 110 performs an XOR operation between new data stored in the write buffer (new data) 202 and the old data stored in the read buffer (old data) 204 to determine a transient XOR result, and stores the transient XOR result in the CMB (trans-XOR) 206. In some arrangements, the write buffer (new data) 202 is a particular implementation of the write buffer 114 of the storage device 100a. The read buffer (old data) 204 is a particular implementation of the read buffer 116 of the storage device 100a. The CMB (trans-XOR) 206 is a particular implementation of the buffer 112 of the storage device 100a. In other arrangements, to conserve memory resources, the CMB (trans-XOR) 206 can be the same as the read buffer (old data) 204 and is a particular implementation of the buffer 112 of the storage device 100a, such that the transient XOR results can be written over the content of the read buffer (old data) 204. In this way only one data transfer is performed from the NAND page to the read buffer (old data) 204 and then the XOR result calculated in place in the same location, not requiring any data to be transferred.

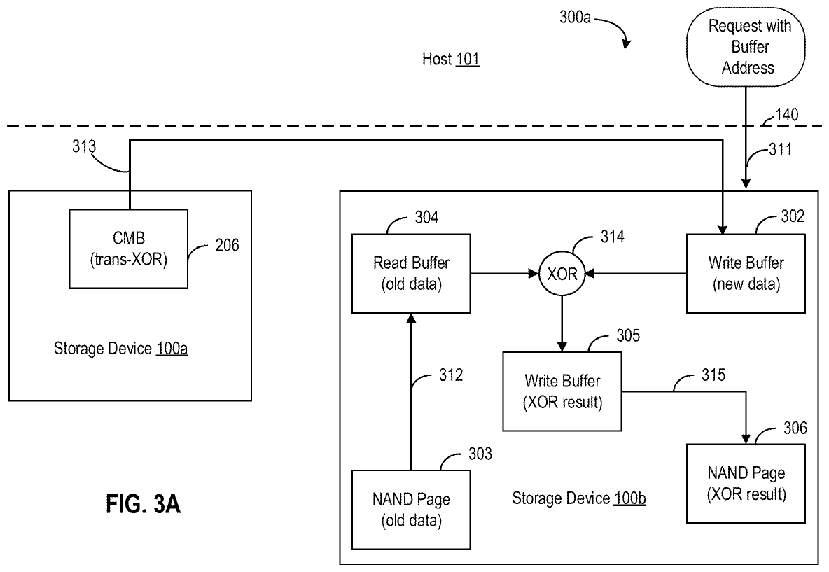

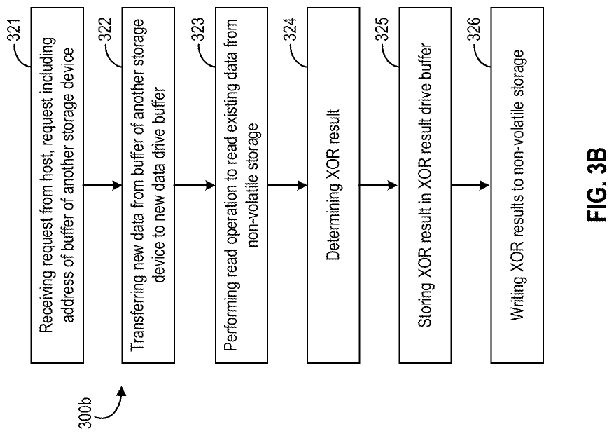

The transient XOR result from the CMB (trans-XOR) 206 is not transferred across the interface 140 into the host 101. Instead, the transient XOR result in the CMB (trans-XOR) 206 can be directly transferred to a parity drive (e.g., the storage device 100b) to update the parity data corresponding to the updated, new data. This is discussed in further detail with reference to FIGS. 3A and 3B.

FIG. 2B is a flowchart diagram illustrating an example method 200b for performing data update, according to some implementations. Referring to FIGS. 1, 2A, and 2B, the method 200b corresponds to the method 200a. The method 200b can be performed by the controller 110 of the storage device 100a.

At 221, the controller 110 receives a new type of write request from the host 101 operatively coupled to the storage device 100a. At 222, in response to receiving the new type of write request, the controller 110 transfers the new data (new regular, non-parity data) from the host 101 (e.g., from the host buffer (new data) 201) to a write buffer (e.g., the write buffer (new data) 202) of the storage device 100a across through the bus 106 and via the interface 140. Thus, the controller 110 receives the new data corresponding to the logical address identified in the write request from the host 101. At 223, the controller 110 performs a read operation to read the existing (old) data from a non-volatile storage (e.g., from the NAND page (old data) 203) into an existing data drive buffer (e.g., the read buffer (old data) 204) located in the memory area accessible by other devices (i.e. the CMB). The existing data has the same logical address as the new data, as identified in the write request.

At 224, the controller 110 writes the new data stored in the new data drive buffer of the storage device 100a to the non-volatile storage (e.g., the NAND page (new data) 205). As noted, the new data and the existing data correspond to the same logical address, although located in different physical NAND pages. The existing data is at a first physical address of the non-volatile storage (e.g., at the NAND page (old data) 203). Writing the new data to the non-volatile storage includes writing the new data to a second physical address of the non-volatile storage (e.g., at the NAND page (new data) 205) and updating Logic-to-Physical (L2P) mapping to correspond the logical address to the second physical address. Blocks 223 and 224 can be performed in any suitable order or simultaneously.

At 225, the controller 110 determines an XOR result by performing an XOR operation of the new data and the existing data. The XOR result is referred to as a transient XOR result. At 226, the controller 110 temporarily stores the transient XOR result in a transient XOR result drive buffer (e.g., the CMB (trans-XOR) 206) after determining the transient XOR result.

Given that updating data on a data drive (e.g., the methods 200a and 200b) is followed by a corresponding update of parity on the parity drive (e.g., the methods 300a and 300b) to uphold integrity of the RAID 5 group protection, the efficiency is in reality a sum of both processes. In other words, every write in the conventional mechanism causes 4 I/O operations (read old data, read old parity, write new data, and write new parity). In the mechanism described herein, the number of I/O operations is reduced by half, to two (write new data, write new parity).

Traditionally, to update parity data (or parity) on a parity drive in a RAID 5 group, the following steps are performed. The host 101 submits a NVMe read request over the interface 140 to the controller 110 of the parity drive. In response, the controller 110 performs a NAND read into a drive buffer. In other words, the controller 110 reads the data (old, existing parity data) requested in the read request from the memory array 120 (one or more of the NAND flash memory devices 130a-130n) and stores the data in the read buffer 116. The controller 110 transfers the data from the read buffer 116 across the interface 140 into the memory 102 (e.g., an old data buffer). The old data buffer of the host 101 therefore stores the old data read from the memory array 120. The host 101 then performs an XOR operation between (i) data that the host 101 has already computed earlier (referred to as transient XOR data) and residing in the memory 102 (e.g., a trans-XOR buffer) and (ii) the old data read from the memory array 120 and stored in the old data buffer of the host 101. The result (referred to as new data) is then stored in the memory 102 (e.g., a new data buffer). In some cases, the new data buffer can potentially be the same as either the old data buffer or the trans-XOR buffer, as the new data can replace existing contents in those buffers, to conserve memory resources. The host 101 then submits a NVMe write request to the controller 110 and presents the new data from the new data buffer to the controller 110. In response, controller 110 then performs a data transfer to obtain the new data from the new data buffer of the host 101 across the interface 140, and stores the new data into the write buffer 116. The controller 110 then updates the old, existing data by writing the new data into the memory array 120 (e.g., one or more of the NAND flash memory devices 130a-130n). The new data and the old data share the same logical address (e.g., the same LBA) and have different physical addresses (e.g., stored in different NAND pages of the NAND flash memory devices 130a-130n), due to the nature of operation of NAND flash memory. The controller 110 also updates a logical to physical mapping table to take note of the new physical address.

On the other hand, some arrangements for updating parity data stored in the memory array 120 of a parity drive (e.g., the storage device 100b as an example) include not only performing the XOR computation within the controller 110 of the parity drive instead of within the processor 104, but also transferring transient XOR data directly from the buffer 112 of a data drive (e.g., the storage device 100a as an example) without using the memory 102 of the host 101. In that regard, FIG. 3A is a block diagram illustrating an example method 300a for performing parity update, according to some implementations. Referring to FIGS. 1-3A, the method 300a provides improved I/O efficiency, host CPU efficiency, memory resource efficiency, and data transfer efficiency as compared to the conventional parity update method noted above. The method 300a can be performed by the host 101, the storage device 100a (the data drive), and the storage device 100b (the parity drive storing parity data of the data stored on the data drive).

The NAND page (old data) 303 and the NAND page (XOR result) 306 are different pages in the NAND flash memory devices 130a-130n of the storage device 100b. The NAND page (old data) 203a and the NAND page (new data) 206b are different pages in the NAND flash memory devices 130a-130n of the storage device 100b.

In the method 300a, the host 101 submits a new type of NVMe write command or request over the interface 140 to the controller 110 of the storage device 100b, at 311. In some implementations, the new type of NVMe write command or request may resemble a traditional NVMe write command or request, but with a different command opcode or a flag to indicate that the command is not a normal NVMe write command and that the command should be processed according to the method described herein. The write request includes a reference to an address of the CMB (trans-XOR) 206 of the storage device 100a. Examples of the reference include but are not limited to, an address, a CMB address, an address descriptor, an identifier, a pointer, or another suitable indicator that identifies the buffer 112 of a storage device. As described in the methods 200a and 200b, the CMB (trans-XOR) 206 stores the transient XOR result that is determined by the controller 110 of the storage device 100a by performing an XOR operation of the new data and the existing data (e.g., at 214). Accordingly, the write request received by the controller 110 of the storage device 100b at 311 does not include the transient XOR result, and instead includes an address of the buffer of the data drive that temporary stores the transient XOR result. The write request further includes a logical address (e.g., LBA) of where the new data (e.g., of the transient XOR result, which is parity data) will be written in storage device 100b.

The controller 110 performs a NAND read into a read buffer (new data) 304, at 312. In other words, the controller 110 reads the old and existing data, corresponding to the logical address in the host's write request received at 311, from the memory array 120 (e.g., one or more NAND pages (old data) 303 and stores the old data in the read buffer (new data) 304. The old and existing data is located at the old physical address corresponding to the LBA of the new data provided in the write request received at 311. The old physical address is obtained by the controller 110 using a logical to physical look up table. The one or more NAND pages (old data) 303 are pages in one or more of the NAND flash memory devices 130a-130n of the storage device 100b.

At 313, the controller 110 of the storage device 100b performs a P2P read operation to transfer the new data from the CMB (trans-XOR) 206 of the storage device 100a to the write buffer (new data) 302 of the storage device 100b. In other words, the storage device 100b can directly fetch the content (e.g., the XOR transient result) in the CMB (trans-XOR) 206 of the storage device 100a using a suitable transfer mechanism, thus bypassing the memory 102 of the host 101. The transfer mechanism can identify the origin (the CMB (trans-XOR) 206) of the new data to be transferred using the address of the CMB (trans-XOR) 206 received from the host 101 at 311. The transfer mechanism can transfer the data from the origin to the write buffer of storage device 100b (the write buffer (new data) 302). In some implementations, the read operation is performed by the controller 110 of storage device 100b as part of the normal processing of any NVMe write command received from the host 101, with the exception that the address of the data to be written references CMB (trans-XOR) 206 in the storage device 100a and not the host buffer 102. Examples of the transfer mechanism include but not limited to, a DMA transfer mechanism, transfer over a wireless or wired network, transfer over a bus or serial, an intra-platform communication mechanism, or another suitable communication channel connecting the origin and target buffers.

After the new data has been successfully transferred from the CMB (trans-XOR) 206 to the write buffer (new data) 302, the controller 110 of the storage device 100b can acknowledge the write request received at 311 to the host 101, in some examples. In some examples, after the new data has been successfully transferred from the CMB (trans-XOR) 206 to the write buffer (new data) 302 as acknowledged to the controller 110 of the storage device 100a by the transfer mechanism or the controller 110 of the storage device 100b, the controller 110 of the storage device 100a removes the contents of the CMB (trans-XOR) 206 or indicates that the contents of the CMB (trans-XOR) 206 to be invalid.

Relative to the method 300a, the new data and the old data are parity data (e.g., one or more parity bits). In other words, the old data (old parity data) is updated to the new data (new parity data). Other components of the storage device 100a are not shown for clarity.

The controller 110 performs an XOR operation between new data stored in the write buffer (new data) 302 and the old data stored in the read buffer (new data) 304 to determine an XOR result, and stores the XOR result in the write buffer (XOR result) 305, at 314. In some arrangements, the write buffer (new data) 302 is a particular implementation of the write buffer 114 of the storage device 100b. The read buffer (new data) 304 is a particular implementation of the read buffer 116 of the storage device 100b. The write buffer (XOR result) 305 is a particular implementation of the buffer 112 of the storage device 100b. In other arrangements, to conserve memory resources, the write buffer (XOR result) 305 can be the same as the write buffer (new data) 302 and is a particular implementation of the buffer 114 of the storage device 100b, such that the XOR results can be written over the content of the write buffer (new data) 302.

At 315, the controller 110 then updates the old data with the new data by writing the XOR result into a NAND page (XOR result) 306. The controller 110 (e.g., the FTL) updates a logical to physical addressing mapping table to correspond the physical address of the NAND page (XOR result) 306 with the logical address. The controller 110 marks the physical address of the NAND page (old data) 303 as containing invalid data, ready for garbage collection.

FIG. 3B is a flowchart diagram illustrating an example method 300b for performing parity update, according to some implementations. Referring to FIGS. 1-3B, the method 300b corresponds to the method 300a. The method 300b can be performed by the controller 110 of the storage device 100b.

At 321, the controller 110 receives a new type of write request from the host 101 operatively coupled to the storage device 100b, the new type of write request includes an address of a buffer (e.g., the CMB (trans-XOR)206) of another storage device (e.g., the storage device 100a). At 322, in response to receiving the write request, the controller 110 transfers the new data (new parity data) from buffer of another storage device to a new data drive buffer (e.g., the write buffer (new data) 302) using a transfer mechanism. Thus, the controller 110 receives the new data, corresponding to the address of the buffer identified in the write request, from the buffer of another storage device instead of the host 101. At 323, the controller 110 performs a read operation to read the existing (old) data (existing, old parity data) from a non-volatile storage (e.g., from the NAND page (old data) 303) into an existing data drive buffer (e.g., the read buffer (new data) 304). Blocks 322 and 323 can be performed in any suitable order or simultaneously.

At 324, the controller 110 determines an XOR result by performing an XOR operation of the new data and the existing data. At 325, the controller 110 temporarily stores the XOR result in an XOR result drive buffer (e.g., the write buffer (XOR result) 305) after determining the XOR result. At 326, the controller 110 writes the XOR result stored in the XOR result drive buffer to the non-volatile storage (e.g., the NAND page (XOR result) 306). As noted, the new data and the existing data correspond to a same logical address. The existing data is at a first physical address of the non-volatile storage (e.g., at the NAND page (old data) 304). Writing the XOR result to the non-volatile storage includes writing the XOR result to a second physical address of the non-volatile storage (e.g., at the NAND page (XOR result) 306) and updating L2P mapping to correspond the logical address to the second physical address.

The methods 300a and 300b improve upon the conventional parity data update method by executing the XOR operation in the drive hardware (e.g., in the hardware of the storage device 100b as noted), to obviate any need for the XOR operation at host level. In addition, new parity data is transferred directly from the data drive (e.g., the storage device 100a) to the parity drive (storage device 100b) without passing through the host 101. Accordingly, the method 300a and 300b improve I/O efficiency, host CPU efficiency, memory resource efficiency, and data transfer efficiency as compared to the conventional parity update method.

With regard to I/O performance efficiency, the host 101 needs to submit only one request (the write request at 311/321) instead of two requests to update the parity data, and such request includes merely a buffer address instead of the transient XOR data or a buffer address in memory 102 located in the host. In some examples, the work involved for each request includes: 1) the host 101 writes a command into a submission queue; 2) the host 101 writes updated submission queue tail pointer into a doorbell register; 3) the storage device 100b (e.g., the controller 110) fetches the command from the submission queue; 4) the storage device 100b (e.g., the controller 110) processes the command; 5) the storage device 100b (e.g., the controller 110) writes details about the status of completion into a completion queue; 6) the storage device 100b (e.g., the controller 110) informs the host 101 that the command has completed; 7) the host 101 processes the completion; and 8) the host 101 writes the updated completion queue head pointer to doorbell register.

Accordingly, the host 101 does not need to read the existing parity data and perform the XOR of transient XOR data and the existing parity data, nor does the host 101 need to transfer the transient XOR data to its memory 102 and then transfer the transient XOR data from the memory 102 to the parity data device. The mechanisms disclosed herein consume close to 10% of the total elapsed time to fetch 4 KB of data from the storage device 100b, excluding all of the time elapsed within the storage device 100b to fetch the command, process the command, fetch the data from the storage media (e.g., the memory array 120), and complete the XOR operations. Hence, the present arrangements can reduce number of host requests by at least half (from two to one), representing significant efficiency improvements.

With regard to host CPU efficiency, the host computation is more expensive than computation of the storage devices 100, as the cost of host CPU is significantly higher than CPU of the storage devices 100. Consequently, saving computation cycles for the host CPU results in greater efficiency. Studies have estimated that number of CPU clocks per NVMe request required are approximately 34,000. Thus, as each time a parity update needs to be performed, the CPU savings of 34,000 clocks occurs. For comparison purposes, a 12 Gb SAS interface request for an SSD consumes approximately 79,000 clocks per request. With NVMe interface technology, this requirement can be reduced to approximately 34,000—a savings of about 45,000 clock cycles. Considering the elimination for XOR computation at the host level along with the reduction in requests, the efficiency improvement can be compared to the efficiencies provided by the NVMe interface over a SAS interface.

With regard to memory resource efficiency, in addition to savings for the host 101 at the CPU level, there are also savings to be gained in terms of memory consumption. DRAM memory continues to be a precious resource for the host 101, not only because only a limited amount can be added to the host 101 due to limited Dual In-line Memory Module (DIMM) slots but also due to capacity scaling limitations of the DRAM technology itself. In addition, modern applications such as machine learning, in-memory databases, big data analytics increase the need for additional memory at the host 101. Consequently, a new class of devices known as Storage Class Memory (SCM) has emerged to bridge the gap given that DRAM is unable to fill this increased memory need. While this technology is still in its infancy, a vast majority of existing systems are still looking for solutions that can help reduce consumption of memory resources without compromising on other attributes such as cost or performance. The present arrangements reduce memory consumption by eliminating the need to potentially allocate up to two buffers in the host 101 (a savings of up to 200% per request), thus reducing cost.

With regard to data transfer efficiency, a number of data transfers across the NVMe interface for the data copies from a drive buffer (e.g., the buffer 112) to a host buffer (e.g., the memory 102) can be reduced by more than half, which reduces consumption of sought-after hardware resources for DMA transfers and the utilization of the PCIe bus/network. In addition, in an example implementation the storage devices 100a, 100b, 100n may reside in a remote storage appliance, connected to PCI switch and then via PCI switch fabric to a host, such that transfers between storage devices need only travel “upstream” from a source device to the nearest switch before coming back “downstream” to the target device, thus not consuming bandwidth and suffering network fabric delays upstream of the first switch. This reduction in resources and network delay not only reduces power consumption but also improves performance.

Traditionally, to recover data from a failed device in a RAID 5 group, the following steps are performed. The host 101 submits a NVMe read request over the interface 140 to the controller 110 of a first storage device of a series of storage devices of a RAID 5 group. In the RAID 5 group, the nth storage device is the failed device, and the first storage device to the (n−1)th storage device are functional devices. Each storage device in the RAID 5 group is one of the storage devices 100. In response, the controller 110 of the first storage device performs a NAND read into a drive buffer of the first storage device. In other words, the controller 110 reads the data requested in the read request from the memory array 120 (one or more of the NAND flash memory devices 130a-130n) of the first storage device and stores the data in the read buffer 116 of the first storage device. The controller 110 of the first storage device transfers the data from the read buffer 116 of the first storage device across the interface 140 into the memory 102 (e.g., a previous data buffer) of the host 101.

Next, the host 101 submits a NVMe read request over the interface 140 to the controller 110 of a second storage device of the RAID 5 group. In response, the controller 110 of the second storage device performs a NAND read into a drive buffer of the second storage device. In other words, the controller 110 of the second storage device reads the data requested in the read request from the memory array 120 (one or more of the NAND flash memory devices 130a-130n) of the second storage device and stores the data in the read buffer 116 of the second storage device. The controller 110 of the second storage device transfers the data from the read buffer 116 of the second storage device across the interface 140 into the memory 102 (e.g., a current data buffer) of the host 101. The host 101 then performs an XOR operation between (i) the data in the previous data buffer of the host 101 and (ii) the data in current data buffer of the host 101. The result (a transient XOR result) is then stored in a trans-XOR buffer of the host 101. In some cases, the trans-XOR buffer of the host 101 can potentially be the same as either the previous data buffer or the current data buffer, as the transient XOR data can replace existing contents in those buffers, to conserve memory resources.

Next, the host 101 submits a NVMe read request over the interface 140 to the controller 110 of a next storage device of the RAID 5 group to read the current data of the next storage device in the manner described with the second storage device. The host 101 then performs the XOR operation between (i) the data in the previous data buffer, which is the transient XOR result determined in the previous iteration involving a previous storage device and (ii) the current data of the next storage device. Such processes are repeated until the host 101 determines the recovered data by performing an XOR operation between the current data of the (n−1)th storage device and the transient XOR result determined in the previous iteration involving the (n−2)th storage device.

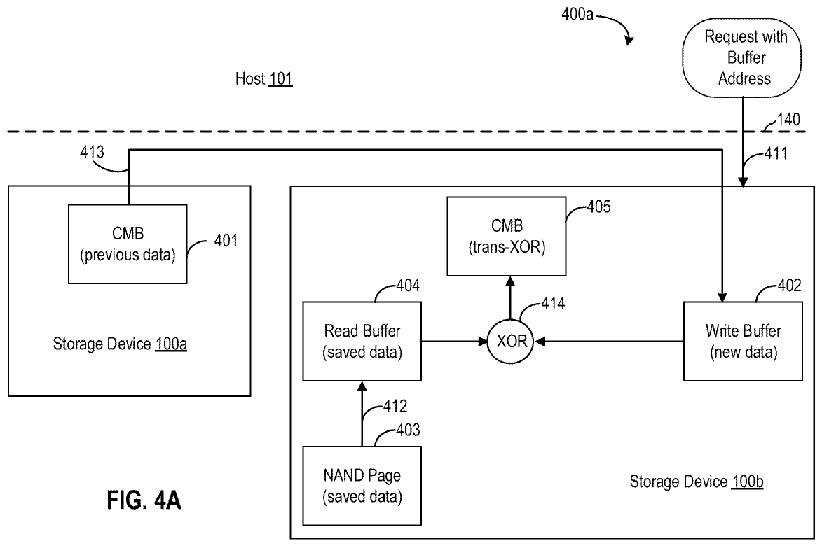

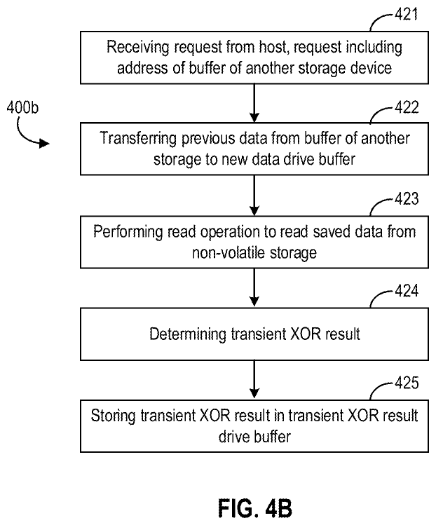

On the other hand, some arrangements for recovering data of a failed device in a RAID 5 group include not only performing the XOR computation within the controller 110 of a storage device instead of within the processor 104, but also transferring transient XOR data directly from the buffer 112 of another storage device without using the memory 102 of the host 101. In that regard, FIG. 4A is a block diagram illustrating an example method 400a for performing data recovery, according to some implementations. Referring to FIGS. 1 and 4A, the method 400a provides improved host CPU efficiency and memory resource efficiency as compared to the conventional data recovery method noted above. The method 400a can be performed by the host 101, the storage device 100a (a previous storage device), and the storage device 100b (a current storage device). The NAND page (saved data) 403 refers to one or more pages in the NAND flash memory devices 130a-130n of the storage device 100b.

FIG. 4A shows one iteration of a data recovery method for a failed, nth device (as an example, the storage device 100n) in a RAID 5 group, which includes the storage devices 100. The current storage device refers to the storage device (as an example, the storage device 100b) that is currently performing the XOR operation in this iteration shown in FIG. 4A. The previous storage device refers to the storage device (as an example, the storage device 100a) from which the current storage device obtains previous data. Thus, the current storage device can be any one of the second to the (n−1)th storage devices in the RAID 5 group.

The CMB (previous data) 401 is an example and a particular implementation of the buffer 112 of the storage device 100a. Components of the storage device 100a other than a CMB (previous data) 401 are not shown in FIG. 4A for clarity.

In the example in which the storage device 100a is the first storage device in the RAID 5 group, the host 101 submits a NVMe read request for a logical address through the bus 106 and over the interface 140 to the controller 110 of the storage device 100a. In response, the controller 110 of the storage device 100a performs a NAND read into a drive buffer (e.g., the CMB (previous data) 401) of the storage device 100a. In other words, the controller 110 reads the beginning data corresponding to the logical address requested in the read request from the memory array 120 (one or more of the NAND flash memory devices 130a-130n) of the storage device 100a and stores the beginning data in the CMB (previous data) 401. The controller 110 of the storage device 100a does not transfer the beginning data from the CMB (previous data) 401 across the interface 140 into the memory 102 of the host 101, and instead temporarily stores the beginning data in the CMB (previous data) 401 to be directly transferred to a subsequent storage device in the RAID 5 group. Thus, in the example in which the storage device 100a is the first storage device of the RAID 5 group, the previous data is the beginning data.

In the example in which the storage device 100a is any storage device between the first storage device and the current storage device 100b the RAID 5 group, the content (e.g., the transient XOR data) in the CMB (previous data) 401 is determined in the same manner that the content of a drive buffer (trans-XOR) 405 of the current storage device 100b is determined. In other words, the storage device 100a is the current storage device of the previous iteration of the data recovery method. Thus, in the example in which the storage device 100a is any storage device between the first storage device and the current storage device 100b the RAID 5 group, the previous data refers to the transient XOR data.

In the current iteration and as shown in FIG. 4A, the host 101 submits a new type of NVMe command or request through the bus 106 and over the interface 140 to the controller 110 of the current storage device 100b, at 411. In some implementations, the new type of request may resemble a traditional NVMe write command, but with a different command opcode or a flag to indicate that the command is not a normal NVMe write command and that the command should be processed according to the method described herein. The new type of NVMe command or request includes a reference to an address of the CMB (previous data) 401 of the previous storage device 100a. Examples of the reference include but are not limited to, an address, a CMB address, an address descriptor, an identifier, a pointer, or another suitable indicator that identifies the buffer 112 of a storage device. Accordingly, the new type of request received by the controller 110 of the storage device 100b at 411 does not include the previous data, and instead includes an address of the buffer of the previous storage device that temporary stores the previous data. The new type of request further includes a logical address (e.g., LBA) of the saved data. However, instead of this LBA being the address of data to be written, as in a regular NVMe write command, in the new type of NVMe command, the LBA refers to the address of saved data which is to be read.

The controller 110 performs a NAND read into a read buffer (saved data) 404, at 412. In other words, the controller 110 reads the saved data, corresponding to the logical address in the new type of request received form the host 101, from the memory array 120 (e.g., one or more NAND pages (saved data) 403) and stores the saved data in the read buffer (saved data) 404. The one or more NAND pages (saved data) 403 are pages in one or more of the NAND flash memory devices 130a-130n of the storage device 100b.

At 413, the controller 110 of the storage device 100b performs a P2P read operation to transfer the previous data from the CMB (previous data) 401 of the storage device 100a to the write buffer (new data) 402 of the storage device 100b. In other words, the storage device 100b can directly fetch the content (e.g., the previous data) in the CMB (previous data) 401 of the storage device 100a using a suitable transfer mechanism, thus bypassing the memory 102 of the host 101. The transfer mechanism can identify the origin (the CMB (previous data) 401) of the previous data to be transferred using the address of the CMB (previous data) 401 received from the host 101 at 411. The transfer mechanism can transfer the data from the origin to the target buffer (the write buffer (new data) 402). Examples of the transfer mechanism include but not limited to, a DMA transfer mechanism, transfer over a wireless or wired network, transfer over a bus or serial, an intra-platform communication mechanism, or another suitable communication channel connecting the origin and target buffers.

After the previous data has been successfully transferred from the CMB (previous data) 401 to the write buffer (new data) 402, the controller 110 of the storage device 100b can acknowledge the new type of request received at 411 to the host 101, in some examples. In some examples, after the previous data has been successfully transferred from the CMB (previous data) 401 to the write buffer (new data) 402 as acknowledged to the controller 110 of the storage device 100a by the transfer mechanism or the controller 110 of the storage device 100b, the controller 110 of the storage device 100a de-allocates the memory used by the CMB (previous data) 401 or indicates that the contents of the CMB (previous data) 401 to be invalid.

At 414, the controller 110 performs an XOR operation between the previous data stored in the write buffer (new data) 402 and the saved data stored in the read buffer (saved data) 404 to determine a transient XOR result, and stores the transient XOR result in the CMB (trans-XOR) 405. In some arrangements, the write buffer (new data) 402 is a particular implementation of the write buffer 114 of the storage device 100a. The read buffer (saved data) 404 is a particular implementation of the read buffer 116 of the storage device 100a. The CMB (trans-XOR) 405 is a particular implementation of the buffer 112 of the storage device 100b. In other arrangements, to conserve memory resources, the CMB (trans-XOR) 405 can be the same as the read buffer (saved data) 404 and is a particular implementation of the buffer 112 of the storage device 100a, such that the transient XOR results can be written over the content of the read buffer (saved data) 404.

The iteration for the current storage device 100b completes at this point, and the transient XOR result becomes the previous data for the next storage device after the current storage device 100b, and the CMB (trans-XOR) 405 becomes the CMB (previous data) 401, in a next iteration. The transient XOR result from the CMB (trans-XOR) 405 is not transferred across the interface 140 into the memory 102 of the host 101, and is instead maintained in the CMB (trans-XOR) 405 to be directly transferred to the next storage device in an operation similar to 413. In the case in which the current storage device 100b is the (n−1) the storage device in the RAID 5 group, the transient XOR result is in fact the recovered data for the failed nth storage device 100n.

FIG. 4B is a flowchart diagram illustrating an example method 400b for performing data recovery, according to some implementations. Referring to FIGS. 1, 4A, and 4B, the method 400b corresponds to the method 400a. The method 400b can be performed by the controller 110 of the current storage device 100b.

At 421, the controller 110 receives a new type of request from the host 101 operatively coupled to the storage device 100b, the new type of request includes an address of a buffer (e.g., the CMB (previous data) 401) of another storage device (e.g., the storage device 100a). At 422, in response to receiving the new type of request, the controller 110 transfers the previous data from buffer of another storage device to a new data drive buffer (e.g., the write buffer (new data) 402) using a transfer mechanism. Thus, the controller 110 receives the previous data corresponding to the address of the buffer identified in the new type of request from the buffer of another storage device instead of the host 101. The new type of request further includes a logical address (e.g., LBA) of the saved data. However, instead of this LBA being the address of data to be written, as in a regular NVMe write command, in the new type of request, the LBA refers to the address of saved data which is to be read. At 423, the controller 110 performs a read operation to read the existing (saved) data (located at the physical address corresponding to the LBA) from a non-volatile storage (e.g., from the NAND page (saved data) 403) into an existing data drive buffer (e.g., the read buffer (saved data) 404). Blocks 422 and 423 can be performed in any suitable order or simultaneously.

At 424, the controller 110 determines an XOR result by performing an XOR operation of the previous data and the saved data. The XOR result is referred to as a transient XOR result. At 425, the controller 110 temporarily stores the transient XOR result in a transient XOR result drive buffer (e.g., the CMB (trans-XOR) 405) after determining the transient XOR result.

Traditionally, to bring a spare storage device in a RAID 5 group into service, the following steps are performed. The host 101 submits a NVMe read request over the interface 140 to the controller 110 of a first storage device of a series of storage devices of a RAID 5 group. In the RAID 5 group, the nth storage device is the spare device, and the first storage device to the (n−1)th storage device are currently functional devices. Each storage device in the RAID 5 group is one of the storage devices 100. In response, the controller 110 of the first storage device performs a NAND read into a drive buffer of the first storage device. In other words, the controller 110 reads the data requested in the read request from the memory array 120 (one or more of the NAND flash memory devices 130a-130n) of the first storage device and stores the data in the read buffer 116 of the first storage device. The controller 110 of the first storage device transfers the data from the read buffer 116 of the first storage device across the interface 140 into the memory 102 (e.g., an previous data buffer) of the host 101.

Next, the host 101 submits a NVMe read request over the interface 140 to the controller 110 of a second storage device of the RAID 5 group. In response, the controller 110 of the second storage device performs a NAND read into a drive buffer of the second storage device. In other words, the controller 110 of the second storage device reads the data requested in the read request from the memory array 120 (one or more of the NAND flash memory devices 130a-130n) of the second storage device and stores the data in the read buffer 116 of the second storage device. The controller 110 of the second storage device transfers the data from the read buffer 116 of the second storage device across the interface 140 into the memory 102 (e.g., a current data buffer) of the host 101. The host 101 then performs an XOR operation between (i) the data in the previous data buffer of the host 101 and (ii) the data in current data buffer of the host 101. The result (a transient XOR result) is then stored in a trans-XOR buffer of the host 101. In some cases, the trans-XOR buffer of the host 101 can potentially be the same as either the previous data buffer or the current data buffer, as the transient XOR data can replace existing contents in those buffers, to conserve memory resources.

Next, the host 101 submits a NVMe read request over the interface 140 to the controller 110 of a next storage device of the RAID 5 group to read the current data of the next storage device in the manner described with the second storage device. The host 101 then performs the XOR operation between (i) the data in the previous data buffer, which is the transient XOR result determined in the previous iteration involving a previous storage device and (ii) the current data of the next storage device. Such processes are repeated until the host 101 determines the recovered data by performing an XOR operation between the current data of the (n−1)th storage device and the transient XOR result determined in the previous iteration involving the (n−2)th storage device. The host 101 stores the recovered data in a recovered data buffer of the host 101.

The recovered data is to be written into the spare, nth storage device for that logical address. For example, the host 101 submits a NVMe write request to the nth device and presents the recovered data buffer of the host 101 to be written. In response, the nth storage device performs a data transfer to obtain the recovered data from the host 101 by transferring the recovered data from the recovered data buffer of the host 101 across the NVMe interface into a drive buffer of the nth storage device. The controller 110 of the nth storage device then updates the old data stored in the NAND pages of the nth-storage device with the recovered data by writing the recovered data from the drive buffer of the nth storage device into one or more new NAND pages. The controller 110 (e.g., the FTL) updates the addressing mapping table to correspond the physical address of the new NAND page with the logical address. The controller 110 marks the physical address of the NAND pages on which the old data had been stored for garbage collection.

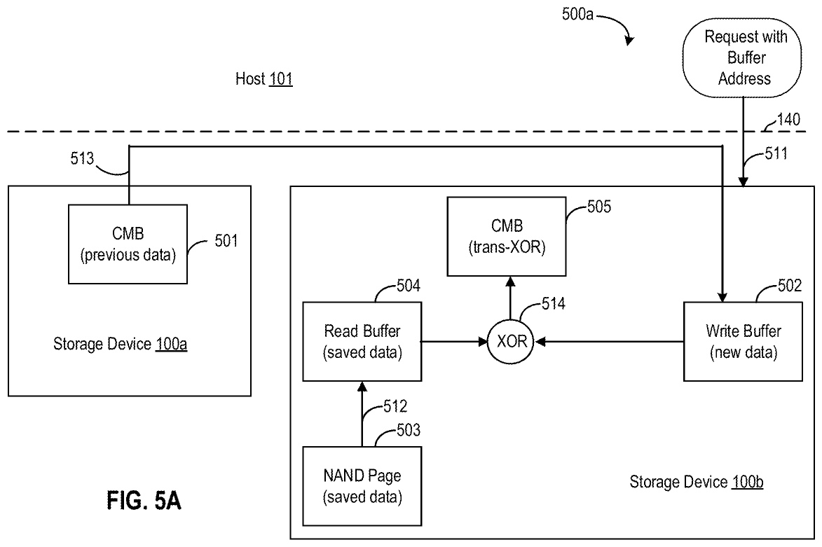

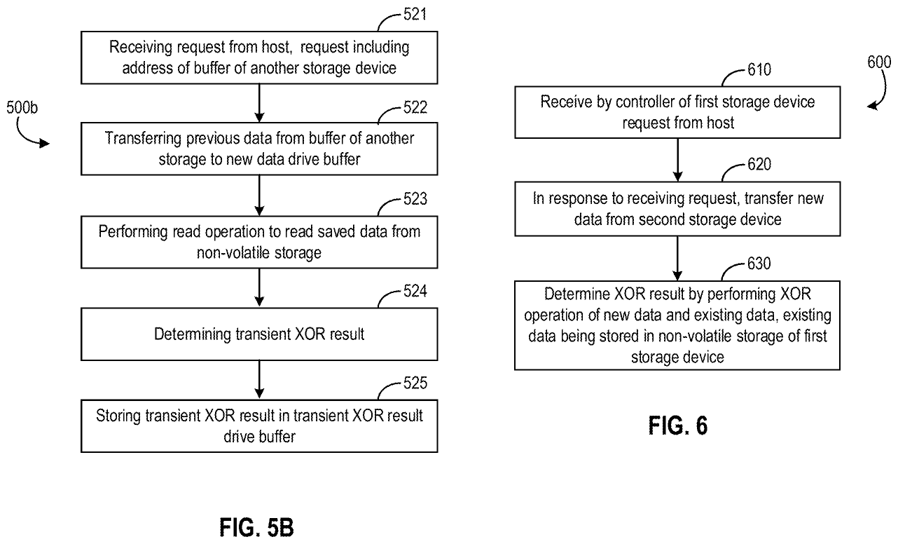

On the other hand, some arrangements for bringing a spare storage device in a RAID 5 group into service include not performing the XOR computation the controller 110 of a storage device instead of within the processor 104, but also transferring transient XOR data directly from the buffer 112 of another storage device without using the memory 102 of the host 101. In that regard, FIG. 5A is a block diagram illustrating an example method 500a for bringing a spare storage device into service, according to some implementations. Referring to FIGS. 1 and 5A, the method 500a provides improved host CPU efficiency and memory resource efficiency as compared to the conventional method for bringing a spare storage device into service as noted above. The method 500a can be performed by the host 101, the storage device 100a (a previous storage device), and the storage device 100b (a current storage device). The NAND page (saved data) 503 refers to one or more pages in the NAND flash memory devices 130a-130n of the storage device 100b.

FIG. 5A shows one iteration of bringing into service the spare, nth device (as an example, the storage device 100n) in a RAID 5 group, which includes the storage devices 100. The current storage device refers to the storage device (as an example, the storage device 100b) that is currently performing the XOR operation in this iteration shown in FIG. 5A. The previous storage device refers to the storage device (as an example, the storage device 100a) from which the current storage device obtains previous data. Thus, the current storage device can be any one of the second to the (n−1)th storage devices in the RAID 5 group.

The CMB (previous data) 501 is an example and a particular implementation of the buffer 112 of the storage device 100a. Components of the storage device 100a other than a CMB (previous data) 501 are not shown in FIG. 5A for clarity.

In the example in which the storage device 100a is the first storage device in the RAID 5 group, the host 101 submits a NVMe read request for a logical address through the bus 106 and over the interface 140 to the controller 110 of the storage device 100a. In response, the controller 110 of the storage device 100a performs a NAND read into a drive buffer (e.g., the CMB (previous data) 501) of the storage device 100a. In other words, the controller 110 reads the beginning data corresponding to the logical address requested in the read request from the memory array 120 (one or more of the NAND flash memory devices 130a-130n) of the first storage device and stores the beginning data in the buffer 112 of the storage device 100a. The controller 110 of the storage device 100a does not transfer the beginning data from the CMB (previous data) 501 across the interface 140 into the memory 102 of the host 101, and instead temporarily stores the beginning data in the CMB (previous data) 501 to be directly transferred to a subsequent storage device in the RAID 5 group. Thus, in the example in which the storage device 100a is the first storage device of the RAID 5 group, the previous data is the beginning data.

In the example in which the storage device 100a is any storage device between the first storage device and the current storage device 100b the RAID 5 group, the content (e.g., the transient XOR data) in the CMB (previous data) 501 is determined in the same manner that the content of a CMB (trans-XOR) 505 of the current storage device 100b is determined. In other words, the storage device 100a is the current storage device of the previous iteration of the data recovery method. Thus, in the example in which the storage device 100a is any storage device between the first storage device and the current storage device 100b the RAID 5 group, the previous data refers to the transient XOR data.

In the current iteration and as shown in FIG. 5A, the host 101 submits a new type of NVMe command or request through the bus 106 and over the interface 140 to the controller 110 of the current storage device 100b, at 511. In some implementations, the new type of request may resemble a traditional NVMe write command, but with a different command opcode or a flag to indicate that the command is not a normal NVMe write command and that the command should be processed according to the method described herein. The new type of NVMe command or request includes a reference to an address of the CMB (previous data) 501 of the previous storage device 100a. Examples of the reference include but are not limited to, an address, a CMB address, an address descriptor, an identifier, a pointer, or another suitable indicator that identifies the buffer 112 of a storage device. Accordingly, the new type of request received by the controller 110 of the storage device 100b at 511 does not include the previous data, and instead includes an address of the buffer of the previous storage device that temporary stores the previous data. The new type of request further includes a logical address (e.g., LBA) of the saved data. However, instead of this LBA being the address of data to be written, as in a regular NVMe write command, in the new type of NVMe command, the LBA refers to the address of saved data which is to be read.

The controller 110 performs a NAND read into a read buffer (saved data) 504, at 512. In other words, the controller 110 reads the saved data, corresponding to the logical address in the new type of request received from the host 101, from the memory array 120 (e.g., one or more NAND pages (saved data) 503 and stores the saved data in the read buffer (saved data) 504. The one or more NAND pages (saved data) 503 are pages in one or more of the NAND flash memory devices 130a-130n of the storage device 100b.

At 513, the controller 110 of the storage device 100b performs a P2P read operation to transfer the previous data from the CMB (previous data) 501 of the storage device 100a to the write buffer (new data) 502 of the storage device 100b. In other words, the storage device 100b can directly fetch the content (e.g., the previous data) in the CMB (previous data) 501 of the storage device 100a using a suitable transfer mechanism, thus bypassing the memory 102 of the host 101. The transfer mechanism can identify the origin (the CMB (previous data) 501) of the previous data to be transferred using the address of the CMB (previous data) 501 received from the host 101 at 511. The transfer mechanism can transfer the data from the origin to the target buffer (the write buffer (new data) 502). Examples of the transfer mechanism include but not limited to, a DMA transfer mechanism, transfer over a wireless or wired network, transfer over a bus or serial, an intra-platform communication mechanism, or another suitable communication channel connecting the origin and target buffers.

After the previous data has been successfully transferred from the CMB (previous data) 501 to the write buffer (new data) 502, the controller 110 of the storage device 100b can acknowledge the write request received at 511 to the host 101, in some examples. In some examples, after the previous data has been successfully transferred from the CMB (previous data) 501 to the write buffer (new data) 502 as acknowledged to the controller 110 of the storage device 100a by the transfer mechanism or the controller 110 of the storage device 100b, the controller 110 of the storage device 100a de-allocates the memory used by the CMB (previous data) 501 or indicates that the contents of the CMB (previous data) 501 to be invalid.

At 514, the controller 110 performs an XOR operation between the previous data stored in the write buffer (new data) 502 and the saved data stored in the read buffer (saved data) 504 to determine a transient XOR result, and stores the transient XOR result in the CMB (trans-XOR) 505. In some arrangements, the write buffer (new data) 502 is a particular implementation of the write buffer 114 of the storage device 100b. The read buffer (saved data) 504 is a particular implementation of the read buffer 116 of the storage device 100b. The CMB (trans-XOR) 505 is a particular implementation of the buffer 112 of the storage device 100b. In other arrangements, to conserve memory resources, the CMB (trans-XOR) 505 can be the same as the read buffer (saved data) 504 and is a particular implementation of the buffer 112 of the storage device 100b, such that the transient XOR results can be written over the content of the read buffer (saved data) 504.

The iteration for the current storage device 100b completes at this point, and the transient XOR result becomes the previous data for the next storage device after the current storage device 100b, and the CMB (trans-XOR) 505 becomes the CMB (previous data) 501, in a next iteration. The transient XOR result from the CMB (trans-XOR) 505 is not transferred across the interface 140 into the memory 102 of the host 101, and is instead maintained in the CMB (trans-XOR) 505 to be directly transferred to the next storage device in an operation similar to 513. In the case in which the current storage device 100b is the (n−1) the storage device in the RAID 5 group, the transient XOR result is in fact the recovered data for the spare nth storage device 100n and is stored in the memory array 120 of the storage device 100n.

FIG. 5B is a flowchart diagram illustrating an example method 500b for bringing a spare storage device into service, according to some implementations. Referring to FIGS. 1, 5A, and 5B, the method 500b corresponds to the method 500a. The method 500b can be performed by the controller 110 of the storage device 100b.

At 521, the controller 110 receives a new type of request from the host 101 operatively coupled to the storage device 100, the new type of request includes an address of a buffer (e.g., the CMB (previous data) 501) of another storage device (e.g., the storage device 100a). At 522, in response to receiving the new type of request, the controller 110 transfers the previous data from buffer of another storage device to a new data drive buffer (e.g., the write buffer (new data) 502) using a transfer mechanism. Thus, the controller 110 receives the previous data corresponding to the address of the buffer identified in the new type of request from the buffer of another storage device instead of the host 101. The new type of request further includes a logical address (e.g., LBA) of the saved data. However, instead of this LBA being the address of data to be written, as in a regular NVMe write command, in the new type of request, the LBA refers to the address of saved data which is to be read. At 523, the controller 110 performs a read operation to read the existing (saved) data from a non-volatile storage (e.g., from the NAND page (saved data) 503) into an existing data drive buffer (e.g., the read buffer (saved data) 504). Blocks 522 and 523 can be performed in any suitable order or simultaneously.

At 524, the controller 110 determines an XOR result by performing an XOR operation of the previous data and the saved data. The XOR result is referred to as a transient XOR result. At 525, the controller 110 temporarily stores the transient XOR result in a transient XOR result drive buffer (e.g., the CMB (trans-XOR) 505) after determining the transient XOR result.

FIG. 6 is a process flow diagram illustrating an example method 600 for providing data protection and recovery for drive failures, according to some implementations. Referring to FIGS. 1-6, the method 600 is performed by the controller 110 of a first storage device (e.g., the storage device 100b). Methods 200a, 200b, 300a, 300b, 400a, 400b, 500a, and 500b are particular examples of the method 600.

At 610, the controller 110 of the first storage device receives a new type of request from the host 101. The host 101 is operatively coupled to the first storage device through the interface 140. In some examples, the new type of request includes an address of a buffer of a second storage device (e.g., the storage device 100a). At 620, in response to receiving the new type of request, the controller 110 of the first storage device transfers new data from the second storage device. At 630, the controller 110 of the first storage device determines an XOR result by performing an XOR operation of the new data and existing data. The existing data is stored in the non-volatile storage (e.g., in the memory array 120) of the first storage device.

In some arrangements, in response to receiving the new type of request, the controller 110 of the first storage device transfers the new data from the buffer of the second storage device to a new data drive buffer of the first storage device using a transfer mechanism based on the address of the buffer of the second storage device. The controller 110 performs a read operation to read the existing data from the non-volatile storage (e.g., in the memory array 120) into an existing data drive buffer

As described with reference to updating parity data (e.g., the methods 300a and 300b), the controller 110 of the first storage device is further configured to store the XOR result in an XOR result drive buffer (e.g., the write buffer (XOR result) 305) after being determined and write the XOR result to the non-volatile storage (e.g., to the NAND page (XOR result) 306). The new data and the existing (old) data correspond to a same logical address (same LBA). The existing data is at a first physical address of the non-volatile storage (e.g., the NAND page (old data) 303). The controller 110 of the first storage device writes the XOR result to the non-volatile storage includes writing the XOR result to a second physical address of the non-volatile storage (e.g., the NAND page (XOR result) 306) and updating the L2P mapping to correspond to the logical address to the second physical address. The existing data and the new data are parity bits.

As described with reference to performing data recovery (e.g., the methods 400a and 400b), the XOR result corresponds to a transient XOR result. The transient XOR result from a transient XOR result drive buffer (e.g., the CMB (trans-XOR) 405) of the first storage device is transferred as previous data to a third storage device without being sent to the host 101 across the interface 104. The third storage device is a next storage device after the first storage device in a series of storage devices

As described with reference to bringing a spare storage device into service (e.g., the methods 500a and 500b), the XOR result corresponds to a transient XOR result. The transient XOR result from a transient XOR result drive buffer e.g., the CMB (trans-XOR) 505) of the first storage device is transferred as recovered data to a third storage device without being sent to the host 101 across the interface 104. The third storage device is a spare storage device being bought into service. The recovered data is stored by a controller of the third storage device in a non-volatile memory of the third storage device.

In a host-directed P2P transfer mechanism as disclosed in methods 300a, 300b, 400a, 400b, 500a, and 500b, the host 101 sends new types of commands or requests to the storage device 100b to trigger the transfer of data from the buffer 112 of the storage device 100a to a buffer of the storage device 100b. The resulting status of the write command or request is reported back to the host by storage device 100b.

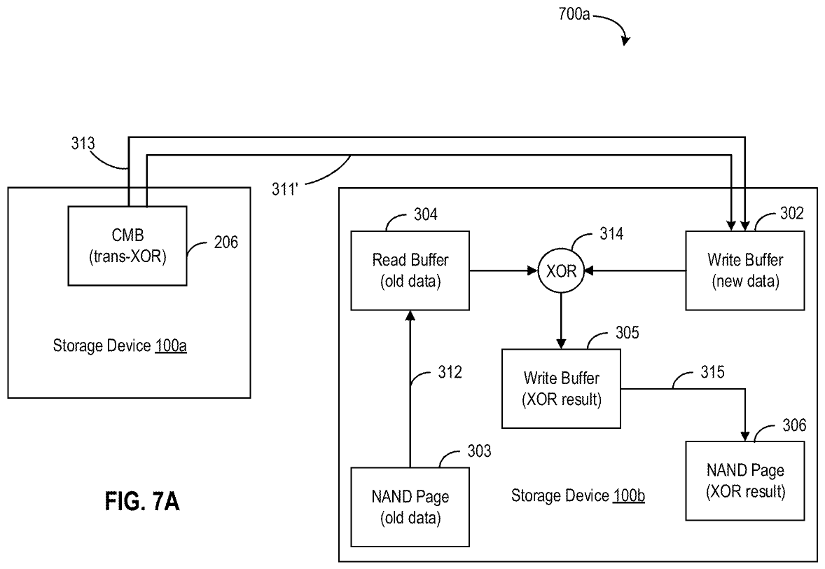

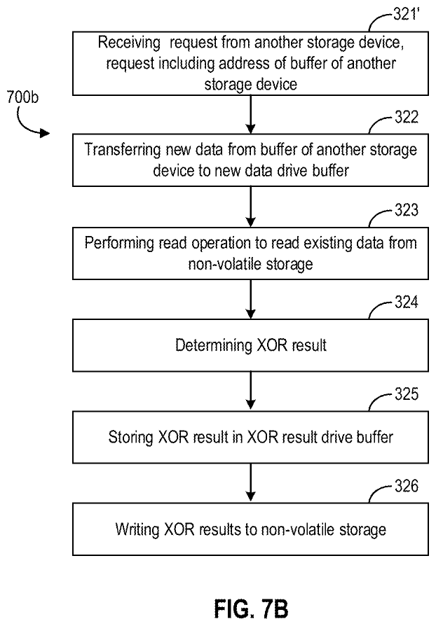

In a device-directed P2P transfer mechanism, the storage device 100a sends the new type of command or request (including buffer address) to the storage device 100b to trigger the transfer of data from the buffer 112 of the storage device 100a to the buffer of the storage device 100b. FIGS. 7A-10 illustrate device-directed P2P transfer mechanism. The resulting status of the new type of command or request is reported back to storage device 100a by storage device 100b. Storage device 100a takes the resulting status of storage device 100b into account before reporting on the resulting status of the host command or request for data write update that it first received which consequently triggered the parity write update by storage device 100b.

In a host-directed P2P transfer mechanism, given that the new type of request is sent to the parity drive in parity update, the parity drive is responsible for returning the status to the host 101. Whereas in a device-directed P2P transfer mechanism, the host 101 does not send that request to the parity drive, thus eliminating one more I/O (thus from 2 to 1). Instead, the host 101 implicitly delegates the responsibility to the data drive, when the host 101 first makes the request to update data. The data drive after having calculated the transient XOR sends it over to the parity drive by initiating the new type of request (on behalf of the host 101) with the CMB address. Because the parity drive received the request from data drive, the parity drive returns the resulting status back to the data drive, not to the host 101. The host 101 is not aware of this transaction, but of course is requesting this transaction to take place implicitly when the host 101 made that first write request by providing the CMB address of the parity drive. The data drive itself does not know which is the parity drive and does need the CMB address information of the parity drive, which the host 101 provides.

FIG. 7A is a block diagram illustrating an example method 700a for performing parity update, according to some implementations. Referring to FIGS. 1-3B, and 7A, the method 700a differs from the method 300a in that at 311′, the controller 110 of the storage device 100a (e.g., the data drive) submits a new type of NVMe write command or request to the controller 110 of the storage device 100b (e.g., the parity drive), via a wireless or wired network, a bus or serial, an intra-platform communication mechanism, or another suitable communication channel between the storage device 100a and the storage device 100b. The new type of request includes a reference to a buffer address of the CMB (trans-XOR) 206 of the storage device 100a, along with a LBA of the location of the data which is being used for an XOR operation for data to be written. Upon receiving the request, the controller 110 of storage device 100b reads at 313 the data located at the buffer CMB (trans-XOR) and transfers it into Write Buffer (new data) 302. Upon controller 110 of storage device 100b notifying storage device 100a of the completion of the request, storage device 100a de-allocates the memory used in buffer CMB (trans-XOR) 206. Examples of the reference include but are not limited to, an address, a CMB address, an address descriptor, an identifier, a pointer, or another suitable indicator that identifies the buffer 112 of a storage device. The transfer at 313 is performed in response to receiving the write request at 311′.

FIG. 7B is a flowchart diagram illustrating an example method 700b for performing parity update, according to some implementations. Referring to FIGS. 1-3B, 7A, and 7B, the method 700b corresponds to the method 700a. The method 700b can be performed by the controller 110 of the storage device 100b. The method 700b differs from the method 300b in that at 321′, the controller 110 of the storage device 100b (e.g., the parity drive) receives a write request from the storage device 100a (e.g., the data drive). Block 322 is performed in response to the request received at 321′.

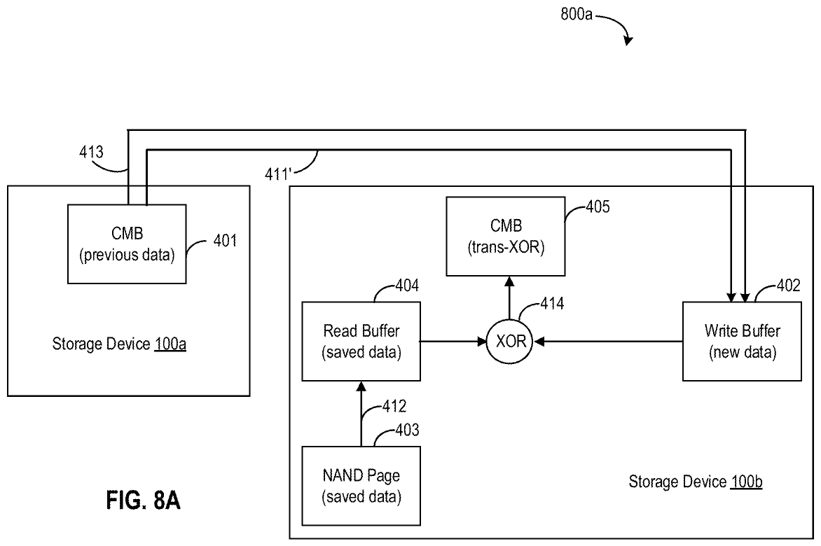

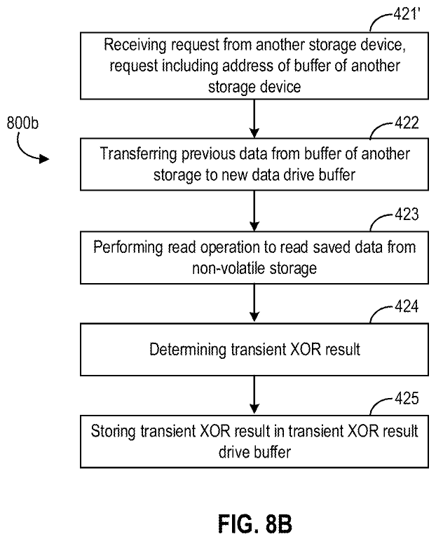

FIG. 8A is a block diagram illustrating an example method 800a for performing data recovery, according to some implementations. Referring to FIGS. 1, 4A, 4B, and 8A, the method 800a differs from the method 400a in that at 411′, the controller 110 of the storage device 100a (e.g., the previous storage device) submits a new type of NVMe write command or request to the controller 110 of the storage device 100b (e.g., the current storage device), via a wireless or wired network, a bus or serial, an intra-platform communication mechanism, or another suitable communication channel between the storage device 100a and the storage device 100b. The request includes a reference to a buffer address of the CMB (previous data) 401 of the storage device 100a, along with a LBA of the location of the data which is to be used in conjunction with the data located at the buffer address used for an XOR operation. Upon receiving the request, the controller 110 of storage device 100b reads at 413 the data located at the buffer CMB (trans-XOR) and transfers it into Write Buffer (new data) 402. Upon controller 110 of storage device 100b notifying storage device 100a of the completion of the request, storage device 100a de-allocates the memory used in buffer CMB (trans-XOR) 206. Examples of the reference include but are not limited to, an address, a CMB address, an address descriptor, an identifier, a pointer, or another suitable indicator that identifies the buffer 112 of a storage device. The transfer at 413 is performed in response to receiving the write request at 411′.

FIG. 8B is a flowchart diagram illustrating an example method 800b for performing data, according to some implementations. Referring to FIGS. 1, 4A, 4B, 8A, and 8B, the method 800b corresponds to the method 800a. The method 800b can be performed by the controller 110 of the storage device 100b. The method 800b differs from the method 400b in that at 421′, the controller 110 of the storage device 100b (e.g., the current storage device) receives a new type of write request from the storage device 100a (e.g., the previous storage device). Block 422 is performed in response to the request received at 421′.

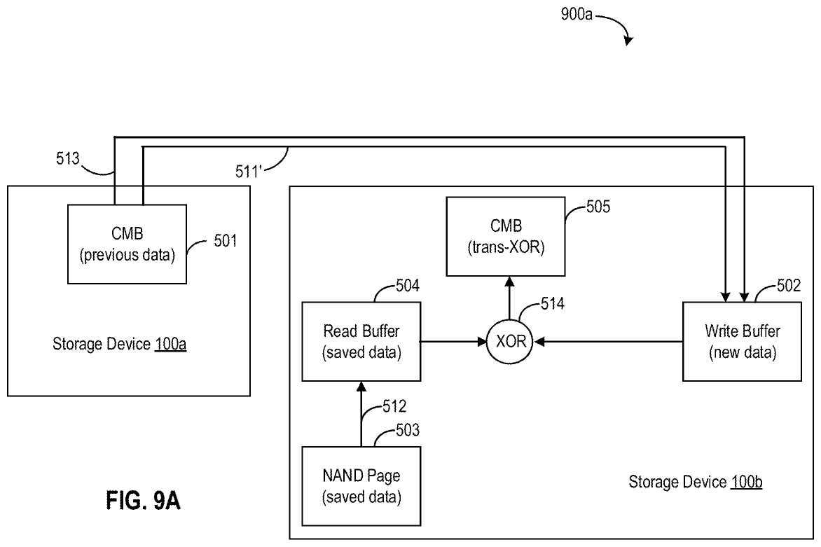

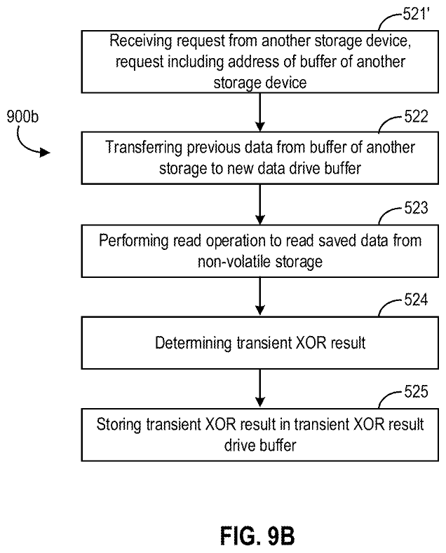

FIG. 9A is a block diagram illustrating an example method 900a for bringing a spare storage device into service, according to some implementations. Referring to FIGS. 1, 5A, 5B, and 9A, the method 900a differs from the method 500a in that at 511′, the controller 110 of the storage device 100a (e.g., the previous storage device) submits a new type of NVMe write command or request to the controller 110 of the storage device 100b (e.g., the current storage device), via a wireless or wired network, a bus or serial, an intra-platform communication mechanism, or another suitable communication channel between the storage device 100a and the storage device 100b. The request includes reference to a buffer address of the CMB (previous data) 501 of the storage device 100a, along with a LBA of the location of the data which is to be used in conjunction with the data located at the buffer address for an XOR operation. Upon receiving the request, the controller 110 of storage device 100b reads at 413 the data located at the buffer CMB (trans-XOR) and transfers it into Write Buffer (new data) 402. Upon controller 110 of storage device 100b notifying storage device 100a of the completion of the request, storage device 100a de-allocates the memory used in buffer CMB (trans-XOR) 206. Examples of the reference include but are not limited to, an address, a CMB address, an address descriptor, an identifier, a pointer, or another suitable indicator that identifies the buffer 112 of a storage device. The transfer at 513 is performed in response to receiving the write request at 511′.

FIG. 9B is a flowchart diagram illustrating an example method 900b for bringing a spare storage device into service, according to some implementations. Referring to FIGS. 1, 5A, 5B, 9A, and 9B, the method 900b corresponds to the method 900a. The method 900b can be performed by the controller 110 of the storage device 100b. The method 900b differs from the method 500b in that at 521′, the controller 110 of the storage device 100b (e.g., the current storage device) receives a new type of write request from the storage device 100a (e.g., the previous storage device). Block 522 is performed in response to the request received at 521′.

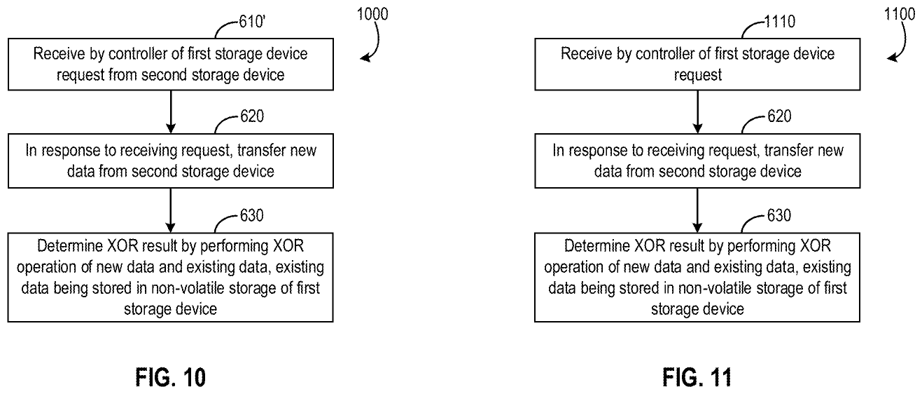

FIG. 10 is a process flow diagram illustrating an example method 1000 for providing data protection and recovery for drive failures, according to some implementations. Referring to FIGS. 1, 6, and 7A-10, the method 1000 is performed by the controller 110 of a first storage device (e.g., the storage device 100b). Methods 700a, 700b, 800a, 800b, 900a, and 900b are particular examples of the method 1000. The method 1000 differs from the method 600 in that at 610′, the controller 110 of the first storage device (e.g., the storage device 100b) receives a new type of write request from the second storage device (e.g., the storage device 100a) instead of from the host 101. In some examples, the new type of write request includes an address of a buffer of a second storage device (e.g., the storage device 100a), along with a LBA of the location of the data which is to be used in conjunction with the data located at the buffer address for an XOR operation. Block 620 is performed in response to block 610′.

FIG. 11 is a process flow diagram illustrating an example method 1100 for providing data protection and recovery for drive failures, according to some implementations. Referring to FIGS. 1-11, the method 1100 is performed by the controller 110 of a first storage device (e.g., the storage device 100b). Methods 200a, 200b, 300a, 300b, 400a, 400b, 500a, 500b, 600, 700a, 700b, 800a, 800b, 900a, 900b, 1000 are particular examples of the method 1100. At 1110, the controller 110 of the first storage device (e.g., the storage device 100b) receives a new type of write request. The new type of write request can be received from the host 101 as disclosed at block 610 in the method 600, in some arrangements. In other arrangements, the new type of write request can be received from the second storage device (e.g., the storage device 100a) as disclosed at block 610′ in the method 1000. Block 620 (in the method 600 and 1000) is performed in response to block 1110 in the method 1100. Block 630 (in the method 600 and 1000) is performed in response to block 620 in the method 1100.

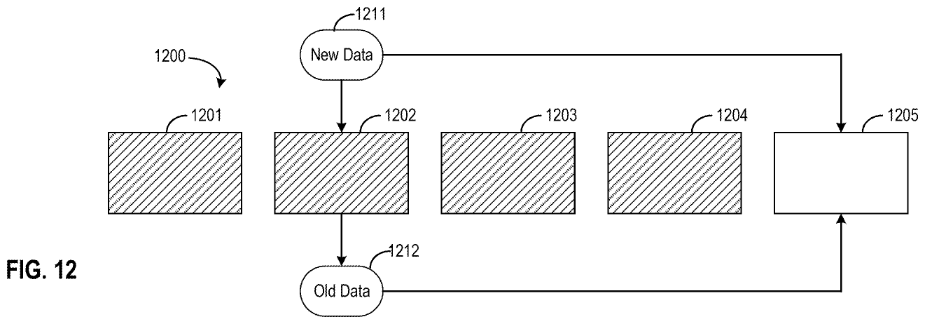

FIG. 12 is a schematic diagram illustrating a host-side view 1200 for updating data, according to some implementations. Referring to FIGS. 1-12, a RAID stripe written by the host 101 includes logical blocks 1201, 1202, 1203, 1204, and 1205. The logical blocks 1201-1204 contain regular, non-parity data. The logical block 1205 contains parity data for the data in the logical blocks 1201-1204. As shown, in response to determining that new data 1211 is to be written to logical block 1202 (originally containing old data) in one of the storage devices 100, instead of performing two XOR operations or storing transient data (e.g., the transient XOR results) as done conventionally, the host 101 merely needs to update the logical block 1205 to the new data 1211. The controllers 110 of the storage devices 100 perform the XOR operations and conduct P2P transfers as described. Both the new data 1211 and the old data 1212 are used to update the parity data in logical block 1205.

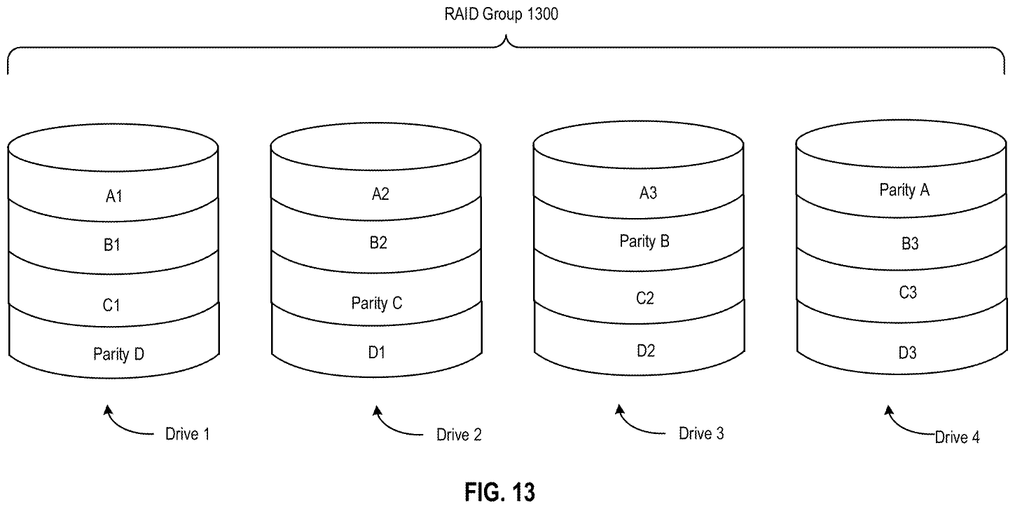

FIG. 13 is a schematic diagram illustrating a placement of parity data, according to some implementations. Referring to FIGS. 1-13, a RAID group 1300 (e.g., a RAID 5 group) includes four drives—Drive 1, Drive 2, Drive 3, an Drive 4. An example of each drive is one of the storage devices 100. Each of the Drives 1-4 stores data and parity data in its respective memory array 120. Four RAID stripes are depicted, A,B,C,D, with stripe A comprising data A1, A2, A3 and Parity A, and so on for stripes B,C and D. Parity A is generated by XORing data A1, A2, and A3 and is stored on Drive 4. Parity B is generated by XORing data B1, B2, and B3 and is stored on Drive 3. Parity C is generated by XORing data C1, C2, and C3 and is stored on Drive 2. Parity D is generated by XORing data D1, D2, and D3 and is stored on Drive 1.

Conventionally, if A3 is to be modified (updated) to A3′, the host 101 reads A1 from Drive 1 and A2 from Drive 2, and XOR A1, A2, and A3′ to generate Parity A′, and writes A3′ to Drive 3 and Parity A′ to Drive 4. Alternatively and also conventionally, in order to avoid having to re-read all the other drives (especially if there were more than four drives in the RAID group), the host 101 can also generate Parity A′ by reading A3 from Drive 3, reading Parity A from Drive 4, and XORing A3, A3′, and Parity A, and then writing A3′ to Drive 3 and Parity A′ to Drive 4. In both conventional cases, modifying A3 would require the host 101 to perform at least two reads from and two writes to drives.

The arrangements disclosed herein can eliminate the host 101 having to read Parity A by enabling the drives (e.g., the controller 110 thereof) to not only perform an XOR operations internally, but also perform P2P transfers of data to generate and store Parity A′. In some examples, the drives can support new types of write commands, which may be Vendor Unique Commands (VUCs) or new commands according to a new NVMe specification which extends the command set of an existing specification, for computing and storing the results of an XOR operation as well as for coordinating P2P transfers of data among the drives.

The host 101 can send, to a first drive, a VUC which contains the LBAs for (1) data or parity data stored on the first drive, and (2) the address of a second drive that contains the data to be XORed with the data or the parity data corresponding to the LBAs. The first drive can read the data or the parity data corresponding to the LBAs sent by the host 101. The read is an internal read, and the read data is not sent back to the host 101. The first drive XORs the data obtained from the second drive based on the address with the internally read data or the parity data, stores the results of the XOR operation in the LBAs corresponding to the data or the parity data which had been read, and confirm successful command completion to the host 101. Such command can be executed in no more time than would be required for comparably sized read and write commands.

The host 101 can send a command to Drive 4 that includes the LBAs for Parity A and an address of another Drive that stores the result of XORing A3 and A3′. In response, Drive 4 computes and stores Parity A′ in the same LBAs that previously contained Parity

A.

In some examples, commands can trigger the XOR operations to be performed within the controller 110. Commands can also trigger P2P transfers. The commands can be implemented over any interface used to communicate to a storage device. In some examples, the NVMe interface commands can be used. For example, the host 101 can send an XFER command (with indicated LBA) to the controller 110, to cause the controller 110 to perform a Computation Function (CF) on the data corresponding the indicated LBAs from the memory array 120. The type of CF to be performed, when the CF is to be performed, and on what data are CF-specific. For example, a CF operation can call for read data from the memory array 120 to be XORed with write data transferred from another drive, before the data is written to the memory array 120.

CF operations are not performed on the metadata in some examples. The host 101 can specify protection information to include as part of the CF operations. In other examples, the XFER command causes the controller 110 to operate on data and metadata, as per CF specified for the logical blocks indicated in the command. The host 101 can likewise specify protection information to include as part of the CF operations.

In some arrangements, the host 101 can invoke a CF on data that is being sent to the storage device 100 (e.g., for a write operation) or requested from the storage device 100 (e.g., for a read operation). In some examples, the CF is applied before saving data to the memory array 120. In some examples, the CF is applied after saving data to the memory array 120. In some examples, the storage device 100 sends data to the host 101 after performing the CF. Examples of the CF includes the XOR operation as described herein, e.g., for RAIDS.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout the previous description that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of steps in the processes disclosed is an example of illustrative approaches. Based upon design preferences, it is understood that the specific order or hierarchy of steps in the processes may be rearranged while remaining within the scope of the previous description. The accompanying method claims present elements of the various steps in a sample order, and are not meant to be limited to the specific order or hierarchy presented.

The previous description of the disclosed implementations is provided to enable any person skilled in the art to make or use the disclosed subject matter. Various modifications to these implementations will be readily apparent to those skilled in the art, and the generic principles defined herein may be applied to other implementations without departing from the spirit or scope of the previous description. Thus, the previous description is not intended to be limited to the implementations shown herein but is to be accorded the widest scope consistent with the principles and novel features disclosed herein.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the steps of various examples must be performed in the order presented. As will be appreciated by one of skill in the art the order of steps in the foregoing examples may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the examples disclosed herein may be implemented or performed with a general purpose processor, a DSP, an ASIC, an FPGA or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary examples, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical drive storage, magnetic drive storage or other magnetic storages, or any other medium that may be used to store desired program code in the form of instructions or data structures and that may be accessed by a computer. Drive and disc, as used herein, includes compact disc (CD), laser disc, optical disc, digital versatile disc (DVD), floppy drive, and blu-ray disc where drives usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable any person skilled in the art to make or use the present disclosure. Various modifications to these examples will be readily apparent to those skilled in the art, and the generic principles defined herein may be applied to some examples without departing from the spirit or scope of the disclosure. Thus, the present disclosure is not intended to be limited to the examples shown herein but is to be accorded the widest scope consistent with the following claims and the principles and novel features disclosed herein.

What is claimed is:

1. A first storage device, comprising:
a non-volatile storage; and
a controller configured to:
receive a request;
in response to receiving the request, transfer new data from a second storage device; and
determine an XOR result by performing an XOR operation of the new data and existing data, the existing data is stored in the non-volatile storage.

2. The first storage device of claim 1, wherein the request is received from a host operatively coupled to the first storage device.

3. The first storage device of claim 1, wherein the request is received from a second storage device.

4. The first storage device of claim 1, wherein the request comprises a reference to a buffer of the second storage device.

5. The first storage device of claim 4, further comprising an existing data drive buffer and a new data drive buffer, wherein
in response to receiving the request, the controller transfers the new data from the buffer of the second storage device to the new data drive buffer using a transfer mechanism based on the reference of the buffer of the second storage device; and
the controller performs a read operation to read the existing data from the non-volatile storage into the existing data drive buffer.

6. The first storage device of claim 4, further comprising an XOR result drive buffer, wherein the controller is further configured to:
store the XOR result in the XOR result drive buffer after being determined; and
write the XOR result to the non-volatile storage.

7. The first storage device of claim 6, wherein
the new data and the existing data correspond to a same logical address;
the existing data is at a first physical address of the non-volatile storage; and
writing the XOR result to the non-volatile storage comprises:
writing the XOR result to a second physical address of the non-volatile storage; and
updating logic-to-physical mapping to correspond to the logical address to the second physical address.

8. The first storage device of claim 6, wherein the existing data and the new data are parity bits.

9. The first storage device of claim 5, further comprising a transient XOR result drive buffer, wherein
the XOR result corresponds to a transient XOR result;
the transient XOR result from the transient XOR result drive buffer is transferred as previous data to a third storage device without being sent to the host across an interface; and
the third storage device is a next storage device after the first storage device in a series of storage devices.

10. The first storage device of claim 5, further comprising a transient XOR result drive buffer, wherein
the XOR result corresponds to a transient XOR result;
the transient XOR result from the transient XOR result drive buffer is transferred as recovered data to a third storage device without being sent to the host across an interface;
the third storage device is a spare storage device being bought into service; and
the recovered data is stored by a controller of the third storage device in a non-volatile memory of the third storage device.

11. A method, comprising:
receiving, by a controller of a first storage device, a request;
in response to receiving the request, transferring, by the controller, new data from a second storage device; and
determining, by the controller, an XOR result by performing an XOR operation of the new data and existing data, the existing data is stored in a non-volatile storage.

12. The method of claim 11, wherein the request is received from a host operatively coupled to the first storage device.

13. The method of claim 11, wherein the request is received from a second storage device.

14. The method of claim 11, wherein the request comprises a reference to a buffer of the second storage device.

15. The method of claim 14, further comprising:
in response to receiving the request, transferring, by the controller, the new data from the buffer of the second storage device to a new data drive buffer of the first storage device using a transfer mechanism based on the reference of the buffer of the second storage device; and
performing, by the controller, a read operation to read the existing data from the non-volatile storage into an existing data drive buffer.

16. A non-transitory computer-readable media comprising computer-readable instructions, such that, when executed, causes a processor of a first storage device to:
receive a request;
in response to receiving the request, transfer new data from a second storage device; and
determine an XOR result by performing an XOR operation of the new data and existing data, the existing data is stored in a non-volatile storage.

17. The non-transitory computer-readable media of claim 16, wherein the request is received from a host operatively coupled to the first storage device.

18. The non-transitory computer-readable media of claim 16, wherein the request is received from a second storage device.

19. The non-transitory computer-readable media of claim 16, wherein the request comprises reference to a buffer of the second storage device.

20. The non-transitory computer-readable media of claim 19, the processor is further caused to:
in response to receiving the request, transfer the new data from the buffer of the second storage device to a new data drive buffer of the first storage device using a transfer mechanism based on the reference of the buffer of the second storage device; and
perform a read operation to read the existing data from the non-volatile storage into an existing data drive buffer.
